(19) United States
(12) Patent Application Publication
(10) Pub. No.: US 2025/0202978 A1
(43) Pub. Date: Jun. 19, 2025

(54) MIRROR PROCESSING METHOD AND APPARATUS, DEVICE, STORAGE MEDIUM, AND PROGRAM PRODUCT

(71) Applicant: Tencent Technology (Shenzhen) Company Limited, Shenzhen (CN)

(72) Inventors: Longhui GOU, Shenzhen (CN); Zixiang SUN, Shenzhen (CN); Qian TANG, Shenzhen (CN); Junliang ZENG, Shenzhen (CN); Jindong ZHANG, Shenzhen (CN); Shuai CAO, Shenzhen (CN); Si LIU, Shenzhen (CN)

(73) Assignee: Tencent Technology (Shenzhen) Company Limited, Shenzhen (CN)

(21) Appl. No.: 19/071,892

(22) Filed: Mar. 6, 2025

Related U.S. Application Data
(63) Continuation of application No. PCT/CN2023/128695, filed on Oct. 31, 2023.

(30) Foreign Application Priority Data
Mar. 15, 2023 (CN) 202310250871.8

(51) Int. Cl. H04L 67/1095

(52) U.S. Cl. CPC H04L 67/1095

(57) ABSTRACT

A mirror processing method includes obtaining a mirror replication request including mirror file information and destination cluster information corresponding to a destination cluster deployed in a destination region different from a source region of a source cluster, wherein the destination cluster is deployed with a destination access layer and a destination control layer; replicating mirror meta-information in a source database of the source cluster to a destination database of the destination cluster, by transmitting the mirror meta-information to the destination access layer, based on the mirror replication request; obtaining the mirror replication request; and replicating a mirror file in a source mirror repository of the source cluster to a destination mirror repository of the destination cluster, by transmitting the mirror file to the destination control layer, based on the mirror replication request.

### CROSS-REFERENCE TO RELATED APPLICATIONS

This application is a continuation application of International Application No. PCT/CN2023/128695 filed on Oct. 31, 2023, which claims priority to Chinese Patent Application No. 202310250871.8 filed with the China National Intellectual Property Administration on Mar. 15, 2023, the disclosures of each being incorporated by reference herein in their entireties.

### FIELD

The disclosure relates to the field of cloud technologies, and to a mirror processing method and apparatus, an electronic device, a computer-readable storage medium, and a computer program product.

### BACKGROUND

With the expansion of business scale of cloud customers and the demand for some edge computing, cloud server clusters deployed in a single region cannot satisfy customer demand, deriving a multi-region deployment architecture. In the multi-region deployment architecture, the production of virtual machines relies heavily on mirrors. Therefore, implementing cross-region replication of mirrors is the key to multi-region deployment.

The foregoing information disclosed in the background section is intended only to enhance understanding of the background of the disclosure, and therefore may include information that does not constitute prior art known to a person of ordinary skill in the art.

### SUMMARY

According to an aspect of the disclosure, a mirror processing method, performed by a source cluster deployed in a source region, includes obtaining a mirror replication request, via a source access layer of the source cluster, wherein the mirror replication request includes mirror file information to be replicated and destination cluster information corresponding to a destination cluster deployed in a destination region different from the source region, and wherein the destination cluster is deployed with a destination access layer and a destination control layer; replicating mirror meta-information in a source database of the source cluster, via the source access layer, to a destination database of the destination cluster, by transmitting the mirror meta-information to the destination access layer, based on the mirror replication request; obtaining the mirror replication request via a source control layer of the source cluster; and replicating a mirror file in a source mirror repository of the source cluster, via the source control layer, to a destination mirror repository of the destination cluster, by transmitting the mirror file to the destination control layer, based on the mirror replication request.

According to an aspect of the disclosure, a mirror processing apparatus, deployed in a source cluster of a source region, includes at least one memory configured to store computer program code; and at least one processor configured to read the program code and operate as instructed by the program code, the program code including first obtaining code configured to cause at least one of the at least one processor to obtain a mirror replication request, via a source access layer of the source cluster, wherein the mirror replication request includes mirror file information to be replicated and destination cluster information corresponding to a destination cluster deployed in a destination region different from the source region, and wherein the destination cluster is deployed with a destination access layer and a destination control layer; first replicating code configured to cause at least one of the at least one processor to replicate mirror meta-information in a source database of the source cluster, via the source access layer, to a destination database of the destination cluster, by transmitting the mirror meta-information to the destination access layer, based on the mirror replication request; second obtaining code configured to cause at least one of the at least one processor to obtain the mirror replication request via a source control layer of the source cluster; and second replicating code configured to cause at least one of the at least one processor to replicate a mirror file in a source mirror repository of the source cluster, via the source control layer, to a destination mirror repository of the destination cluster, by transmitting the mirror file to the destination control layer, based on the mirror replication request.

According to an aspect of the disclosure, a non-transitory computer-readable storage medium, storing computer code which, when executed by at least one processor, causes the at least one processor to at least obtain a mirror replication request, via a source access layer of a source cluster, wherein the mirror replication request includes mirror file information to be replicated and destination cluster information corresponding to a destination cluster deployed in a destination region different from a source region of the source cluster, and wherein the destination cluster is deployed with a destination access layer and a destination control layer; replicate mirror meta-information in a source database of the source cluster, via the source access layer, to a destination database of the destination cluster, by transmitting the mirror meta-information to the destination access layer, based on the mirror replication request; obtain the mirror replication request via a source control layer of the source cluster; and replicate a mirror file in a source mirror repository of the source cluster, via the source control layer, to a destination mirror repository of the destination cluster, by transmitting the mirror file to the destination control layer, based on the mirror replication request.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of a system architecture according to some embodiments.

FIG. 2 is a flowchart of a mirror processing method according to some embodiments.

FIG. 3 is a schematic diagram of a process of operations 202 and 204 shown in FIG. 2 according to some embodiments.

FIG. 4 is a schematic flowchart of an access layer implementation according to FIG. 2 and FIG. 3.

FIG. 5 is a schematic diagram of a process of operation 206 shown in FIG. 2 according to some embodiments.

FIG. 6 is a schematic diagram of a process of operation 510 shown in FIG. 5 according to some embodiments.

FIG. 7 is a schematic diagram of a process of operation 602 shown in FIG. 6 according to some embodiments.

FIG. 8 is a schematic diagram of a process of operation 602 shown in FIG. 6 according to some embodiments.

FIG. 9 is a schematic diagram of a process of operation 816 shown in FIG. 8 according to some embodiments.

FIG. 10 is a schematic diagram of a process of operation 802 shown in FIG. 8 and operation 902 shown in FIG. 9 according to some embodiments.

FIG. 11 is a flowchart of a method according to some embodiments.

FIG. 12 is a schematic diagram of a process of operation 602 shown in FIG. 6 according to some embodiments.

FIG. 13 is a schematic diagram of a process of operation 502 to 506 shown in FIG. 5 according to some embodiments.

FIG. 14 is a schematic diagram of a process of operation 1304 shown in FIG. 13 according to some embodiments.

FIG. 15 is a schematic flowchart of a source control layer interface generating a mirror replication task as in FIG. 13 and FIG. 14, according to some embodiments.

FIG. 16 is a schematic flowchart of a source control layer processing a mirror replication task as in FIG. 2 to FIG. 12, according to some embodiments.

FIG. 17 is a schematic flowchart of cross-region replication of mirrors in a scenario of a cloud native cluster of a private cloud as in FIG. 2 to FIG. 16, according to some embodiments.

FIG. 18 is a block diagram of a mirror processing apparatus according to some embodiments.

FIG. 19 is a block diagram of a mirror processing apparatus according to some embodiments.

FIG. 20 is a schematic structural diagram of an electronic device according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

In addition, features, structures, or characteristics described may be combined in any appropriate manner in any some embodiments. In the following description, details are provided to provide understanding of some embodiments.

In some embodiments, unless otherwise indicated, terms such as “connected” may be understood in a broad sense. For example, the terms may be electrically connected or may communicate with each other, may be directly connected, or may be indirectly connected by using an intermediate medium. Unless otherwise explicitly defined, “a plurality of” means at least two, such as two and three. A person of ordinary skill in the art may understand meanings of the terms in the disclosure based on various situations.

The following explains some terms involved in some embodiments.

A public cloud may refer to a cloud provided by a third-party provider for users to use. The public cloud is available over the Internet, and may be free or low-cost. The core attribute of the public cloud is shared resource services. There are many instances of this cloud that can provide services across today's open public networks.

A private cloud creates a cloud infrastructure and software and hardware resources within a firewall, for various departments within an organization or enterprise to share resources in a data center. In addition to the hardware resources, the private cloud creates cloud device (Infrastructure as a Service, IaaS) software.

A hybrid cloud integrates the public cloud and the private cloud, and is a main mode and development direction of cloud computing in recent years. The private cloud is mainly oriented to enterprise users. In consideration of security, enterprises may store data in the private cloud, but also hope to obtain computing resources of the public cloud. The hybrid cloud is increasingly used. The hybrid cloud mixes and matches the public cloud and the private cloud, to obtain a best effect. Such a personalized solution saves money and is secure.

Cloud native is a cloud-based software architecture idea, and a methodology for implementing software development practice based on a cloud. In a cloud native architecture, applications are located in a cloud instead of a data center. The applications are designed in consideration of a cloud environment, are designed natively for the cloud, and runs optimally on the cloud, fully utilizing and exploiting elasticity+distribution advantages of a cloud platform. The cloud native is also a method for constructing and running the applications by using advantages of a cloud computing software delivery model. These applications are characterized by the capability of implementing rapid and frequent construction, release, and deployment, being decoupled from underlying hardware and an operating system in combination with characteristics of the cloud computing, conveniently satisfying the requirements in aspects such as scalability, availability, and portability, and providing better economy.

In a public cloud environment, a private cloud environment, or a hybrid cloud environment, implementing cross-region replication of mirrors of a virtual machine is the key to multi-region deployment. Cross-region replication of mirrors in the related art may rely on manual execution, which is inefficient. The private cloud environment is used as an example. In the related art, in a process of replicating a mirror in a region A of a cloud native cluster to a region B, the operation and maintenance staff may obtain a mirror material package from a source region, manually upload the mirror material package to a file storage bucket, and then upload the mirror to a destination region.

In the source region mirror replication process of the related art, it can be seen that from preparation of the mirror material package in the source region to importing the mirror material package to the destination region, the entire process of replicating the mirror material package relies heavily on the manual operation of the operation and maintenance staff, and intermediate steps are prone to errors, resulting in an unavailable replicated mirror. The entire process may be poor in terms of ease of use, and may only satisfy the requirement of cross-region replication of mirrors in a cloud native cluster of a private cloud.

Some embodiments provide a mirror processing method. The method may include: based on a mirror replication request including mirror file information to be replicated and destination cluster information, replicating, by a source access layer, mirror meta-information stored in a source database in a source cluster to a destination database in a destination cluster through a destination access layer, and replicating, by a source control layer, a mirror file to be replicated stored in a source mirror repository in the source cluster to a destination mirror repository through a destination control layer. Therefore, through interactions between layers of the source cluster and layers of the destination cluster, the mirror file to be replicated and the mirror meta-information can be automatically replicated across regions respectively, and the efficiency of cross-region replication of mirrors is improved.

The mirror processing method provided in some embodiments may be applied to a public cloud environment, a private cloud environment, and a hybrid cloud environment.

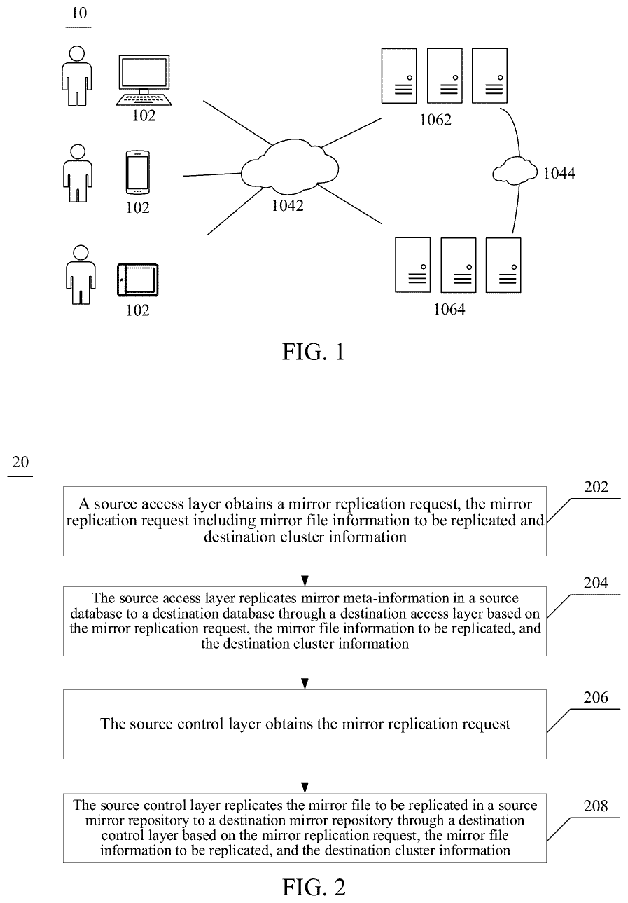

FIG. 1 shows an exemplary system architecture 10 to which the mirror processing method and apparatus of some embodiments may be applied.

As shown in FIG. 1, the system architecture 10 may include a terminal device 102, a network 1042, a network 1044, a server 1062, and a server 1064. The server 1062 and the server 1064 may be an independent physical server, or a server cluster or a distributed system including a plurality of physical servers, or may be a cloud server that provides a cloud service, a cloud database, cloud computing, a cloud function, cloud storage, a network service, cloud communication, a middleware service, a domain name service, a security service, a content delivery network (CDN), and a cloud computing service such as big data and an artificial intelligence platform. The terminal device 102 may be a smartphone, a tablet computer, a laptop portable computer, a notebook computer, a desktop computer, a wearable device, an in-vehicle terminal, a virtual reality device, a smart speaker, a smartwatch, a smart household, or the like, but is not limited thereto. The network 1042 and the network 1044 may include various connection types, for example, a wired communication link, a wireless communication link, or an optical cable. The terminal 102, the server 1062, and the server 1064 may be connected directly or indirectly in a wired or wireless communication manner. However, the disclosure is not limited thereto.

The terminal device 102 may be used to send a mirror replication request to at least one of the server 1062 or the server 1064 through the network 1042, to request to replicate a mirror to be replicated to a cloud server cluster in a region different from the requested server. An example in which the server 1062 is a source cluster deployed in a source region and the server 1064 is a destination cluster deployed in a destination region is used. The server 1062 may be deployed with a source mirror repository and a source database, the source mirror repository stores a mirror file to be replicated, and the source database stores mirror meta-information of the mirror file to be replicated. The server 1064 may include a destination mirror repository and a destination database.

After obtaining the mirror replication request including mirror file information to be replicated and destination cluster information through the network 1042, the server 1062 may replicate the mirror meta-information in the source database to the destination database through the network 1044 based on the mirror replication request, the mirror file information to be replicated, and the destination cluster information. The server 1062 may further replicate the mirror file to be replicated in the source mirror repository to the destination mirror repository through the network 1044 based on the mirror replication request, the mirror file information to be replicated, and the destination cluster information.

Quantities of terminal devices, networks, and servers in FIG. 1 are merely exemplary. There may be any quantity of terminal devices, networks, and servers based on implementation requirements.

FIG. 2 is a flowchart of a mirror processing method according to some embodiments. The method shown in FIG. 2 may be applied to, for example, a server or a terminal device in the foregoing system.

The method shown in FIG. 2 may be performed by a source cluster deployed in a source region, which is configured to replicate a mirror file to be replicated and mirror meta-information of the mirror file to be replicated from the source cluster to a destination cluster. The source region may be a geographical position providing a cloud service, and a virtual machine mirror to be replicated exists in the source region. The source cluster may be a server cluster deployed in the source region, and is configured to provide a cloud service. The source cluster may be deployed with a source access layer and a source control layer, a source mirror repository stores the mirror file to be replicated, and a source database stores mirror meta-information of the mirror file to be replicated. A destination region may be another geographic position that provides a cloud service and that is different from the source region. The destination cluster may be a server cluster deployed in the destination region, and is configured to provide a cloud service. The destination cluster may be deployed with a destination access layer and a destination control layer.

In some embodiments, the source database and the destination database may be databases for recording key fields, with a small storage capacity and a high query speed. For example, the source database and the destination database may be relational databases, such as Oracle, DB2, MySQL, or Microsoft SQL. For another example, the source database and the destination database may also be non-relational databases, such as Redis, Memcache, MongoDb, or HMase.

In some embodiments, the source mirror repository and the destination mirror repository may be file systems for storing large files, such as a distributed file system (DFS), a Hadoop distributed file system (HDFS), a Ceph file system, and a Gluster file system.

Referring to FIG. 2, the method 20 provided in some embodiments may include the following operations 202 to 206.

202: The source access layer obtains a mirror replication request, the mirror replication request including mirror file information to be replicated and destination cluster information.

In some embodiments, the source access layer and the destination access layer may be implemented through an application programming interface (API, interface for short in some embodiments). The access layer may also be referred to as an API layer. In some embodiments, a “source access layer API” represents the source access layer, and a “destination access layer API” represents the destination access layer.

In some embodiments, the mirror replication request may be configured to request to replicate a virtual machine mirror to be replicated in the source cluster to the destination cluster. The to-be-replicated virtual machine mirror may include a mirror file to be replicated and mirror meta-information of the mirror file to be replicated. The mirror meta-information is configured for identifying a feature of the to-be-replicated virtual machine mirror, for example, may include any one or more of a mirror operating system (OS) type, a mirror architecture (arch) version, a mirror version, a mirror name, a mirror message-digest algorithm 5 (md5) value, mirror hierarchical information, and the like, but is not limited thereto.

In some embodiments, a console may be set, so that a user may perform a white-screen operation on a web page displayed on the console, and select the mirror file information to be replicated and the destination cluster information on the page, and the source access layer sends the mirror replication request to the source cluster. The white-screen operation is an operation for the user to implement a corresponding function by interacting with a human-computer interaction interface without writing code.

204: The source access layer replicates the mirror meta-information in the source database to the destination database through the destination access layer based on the mirror replication request, the mirror file information to be replicated, and the destination cluster information.

In some embodiments, the mirror file information to be replicated refers to any related information that can uniquely identify the mirror file to be replicated. For example, each mirror file may be assigned a unique identification (ID). The mirror file information to be replicated may include an ID of the mirror file to be replicated. The mirror file information to be replicated may be configured for searching the source database of the source cluster for the mirror meta-information of the mirror file to be replicated. The destination cluster information may include an identification of the destination region, and the source cluster may be associated with an internet protocol (IP) address of the destination cluster through the identification of the destination region, to implement a network connection between the source cluster and the destination cluster.

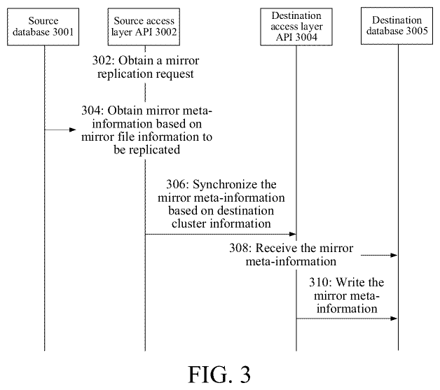

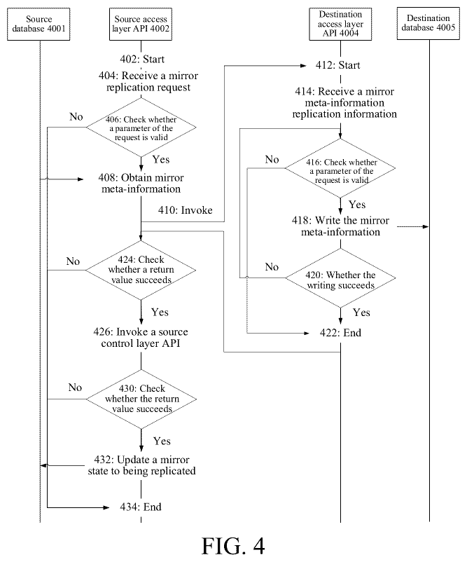

In some embodiments, the source access layer may invoke the destination access layer, to replicate the mirror meta-information in the source database to the destination database. For some embodiments, reference may be made to FIG. 3 and FIG. 4.

206: The source control layer obtains the mirror replication request.

In some embodiments, the source control layer may include a source control layer interface, and the source access layer may synchronize the mirror replication request to the source control layer interface for processing. For some embodiments, reference may be made to FIG. 14 to FIG. 16.

208: The source control layer replicates the mirror file to be replicated in the source mirror repository to a destination mirror repository through the destination control layer based on the mirror replication request, the mirror file information to be replicated, and the destination cluster information.

In some embodiments, the identification of the mirror file to be replicated in the mirror file information to be replicated may be further configured to search the source mirror repository of the source cluster for the mirror file to be replicated. The destination cluster information may include an identification of the destination region, and the source cluster may be associated with an internet protocol (IP) address of the destination cluster through the identification of the destination region, to implement file transfer between the source cluster and the destination cluster.

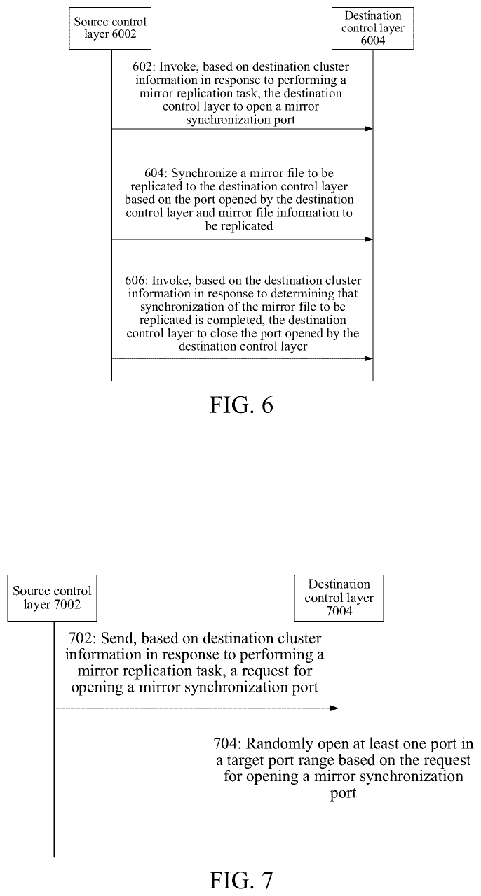

In some embodiments, the mirror replication task may be generated based on the mirror replication request and written into the source database, and the mirror replication task may be obtained from the source database for processing, to implement an asynchronous completion of importing the mirror. For some embodiments, reference may be made to FIG. 6.

In some embodiments, the source access layer may synchronize the mirror replication request to the source control layer, then the source control layer synchronizes the mirror file to be replicated in the source mirror repository to the destination control layer based on the mirror file information to be replicated and the destination cluster information, and replicates the mirror file to be replicated to the destination mirror repository to invoke the access layer. For some embodiments, reference may be made to FIG. 7.

According to the mirror processing method provided in some embodiments, the source access layer of the source cluster deployed in the source region obtains the mirror replication request including the mirror file information to be replicated and the information about the destination cluster deployed in the destination region, the source access layer replicates the mirror meta-information stored in the source database in the source cluster to the destination database in the destination cluster through the destination access layer based on the mirror replication request, the mirror file information to be replicated, and the destination cluster information, and the source control layer replicates the mirror file to be replicated stored in the source mirror repository in the source cluster to the destination mirror repository through the destination control layer based on the mirror replication request, the mirror file information to be replicated, and the destination cluster information, where the destination region is different from the source region. Therefore, through interactions between layers of the source cluster and layers of the destination cluster, the mirror file to be replicated and the mirror meta-information may be automatically replicated across regions respectively at a code level. Compared with the related art in which the mirror file to be replicated and the mirror meta-information are manually packaged into a mirror material package, and after being synchronized across regions, the mirror material package is decompressed into the mirror file to be replicated and the mirror meta-information to be manually uploaded to the mirror repository and the database respectively, the efficiency of cross-region replication of mirrors is improved.

FIG. 3 is a schematic diagram of a process of operations 202 and 204 shown in FIG. 2 in some embodiments. As shown in FIG. 3, in some embodiments, 202 may further include the following operation 302, and operation 204 may further include the following operations 304 to 310.

302: A source access layer API 3002 obtains a mirror replication request.

In some embodiments, the source access layer API 3002 may receive the mirror replication request from a console by providing a hyper text transfer protocol (HTTP) service.

In some embodiments, after receiving the mirror replication request, the source access layer API 3002 may perform validity check on a parameter of the request, and then obtain mirror meta-information from a source database 3001 after the check succeeds. For some embodiments, reference may be made to FIG. 4.

304: The source access layer API 3002 obtains the mirror meta-information from the source database 3001 based on the mirror file information to be replicated.

In some embodiments, the source access layer API 3002 may obtain the mirror meta-information of the mirror file to be replicated from the source database 3001 of the source cluster based on the ID of the mirror file to be replicated in the mirror file information to be replicated.

306: The source access layer API 3002 synchronizes the mirror meta-information to a destination access layer API 3004 based on the destination cluster information.

In some embodiments, the source access layer API 3002 may send a mirror meta-information replication request to the destination access layer API. The destination access layer API may receive the request from the source access layer API 3002 by providing an http service.

308: The destination access layer API 3004 receives the mirror meta-information.

In some embodiments, after obtaining currently received mirror meta-information to be synchronized, the destination access layer API queries a destination database 3005, to determine whether the mirror meta-information exists in a destination region. If it is determined that the mirror meta-information exists in the destination region, skip the writing operation of 310.

310: The destination access layer API 3004 writes the mirror meta-information into the destination database 3005.

In some embodiments, if it is determined that the mirror meta-information does not exist in the destination region, the mirror meta-information is written into the destination database 3005.

According to the method provided in some embodiments, the source access layer invokes the destination access layer, to replicate the mirror meta-information in the source database to the destination database, so that the mirror meta-information can be automatically replicated across regions, thereby improving the efficiency of cross-region replication of mirrors.

FIG. 4 is a schematic flowchart of an access layer implementation according to FIG. 2 and FIG. 3. A procedure of implementing cross-region replication of mirror meta-information by an access layer shown in FIG. 4 may include the following operations 402 to 434.

402: A source access layer API 4002 starts the procedure.

404: The source access layer API 4002 receives a mirror replication request.

406: The source access layer API 4002 checks whether a parameter of the received mirror replication request is valid. If the parameter is valid, perform operation 408. If the parameter is invalid, perform operation 434 to end the procedure.

In some embodiments, the source access layer API 4002 may parse the received mirror replication request, to obtain parameters such as an ID of a mirror file to be replicated and an identification of a destination region.

In some embodiments, the source access layer API 4002 may query a source database 4001 based on the ID of the mirror file to be replicated, to check whether the parameter of the mirror replication request is valid. For example, the source database 4001 may be queried for a mirror state of the mirror file to be replicated, to determine whether the parameter of the mirror replication request is valid. The mirror state may be configured to indicate whether the mirror is an available mirror in a source cluster. For example, the mirror may be taken offline by a user, resulting in an unavailable mirror.

In some embodiments, the source access layer API 4002 may determine, based on the identification of the destination region, whether a region to be synchronized exists, to determine whether the parameter of the mirror replication request is valid.

408: The source access layer API 4002 obtains mirror meta-information from the source database 4001 based on mirror file information to be replicated.

410: The source access layer API 4002 invokes a destination access layer API 4004 to send a mirror meta-information replication request to the destination access layer API 4004. The mirror meta-information replication request may include the ID of the mirror file to be replicated and/or a mirror meta-information identification. For example, the mirror meta-information identification may be a mirror md5 value.

412: The destination access layer API 4004 starts the procedure.

414: The destination access layer API 4004 receives the mirror meta-information replication request.

416: The destination access layer API 4004 checks whether a parameter of the received mirror meta-information replication request is valid. If the parameter is valid, perform operation 418. If the parameter is invalid, perform operation 422 to end the procedure.

In some embodiments, the destination access layer API 4004 may parse the received mirror meta-information replication request, to obtain parameters such as the ID of the mirror file to be replicated and/or the mirror meta-information identification.

In some embodiments, the destination access layer API 4004 may query, based on the parameters such as the ID of the mirror file to be replicated and/or the mirror meta-information identification, whether mirror meta-information to be replicated exists in a destination database 4005, to determine whether the parameter of the received mirror meta-information replication request is valid. If it is obtained through query that the mirror meta-information to be replicated exists in the destination database 4005, it is determined that the parameter of the received mirror meta-information replication request is valid; it may also be determined that the parameter of the received the mirror meta-information replication request is invalid.

418: The destination access layer API 4004 writes the received mirror meta-information into the destination database 4005.

420: The destination access layer API 4004 determines whether the writing succeeds. If the writing fails, perform operation 416. If the writing succeeds, perform operation 422 to end the procedure.

422: The procedure of the destination access layer API 4004 ends, return a return value to the source access layer API 4002, the return value of operation 422 being configured to indicate whether the mirror meta-information is successfully written into the destination database 4005, and then continue to perform operation 424.

424: The source access layer API 4002 checks the return value to determine whether the mirror meta-information is successfully written. If the writing fails, perform 434 to end the procedure. If the writing succeeds, perform operation 426.

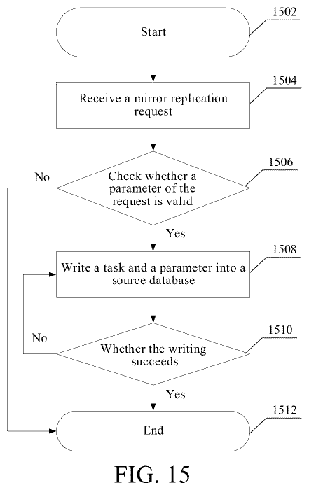

426: The source access layer API 4002 invokes a source control layer API to replicate the mirror file to be replicated. The operation may cause the procedure in FIG. 15 to start.

430: Return a return value to the source access layer API 4002 after the procedure of FIG. 15 ends, the return value of operation 430 being configured to indicate whether the mirror file to be replicated is successfully written into a destination mirror repository, and the source access layer API 4002 checks the return value to determine whether the mirror file to be replicated is successfully written. If the writing fails, perform operation 434 to end the procedure. If the writing succeeds, perform operation 432.

432: The source access layer API 4002 updates the mirror state of the mirror file to be replicated in the source database 4001 to being replicated, and then performs operation 434 to end the procedure.

In some embodiments, at different stages and in different cases, a state of the mirror file to be replicated in the source database 4001 may include to be replicated, being replicated, replicated, or the like, or may include unavailable (caused by being taken offline by the user, or the like). Before operation 432, the state of the mirror file to be replicated in the source database 4001 may be to be replicated.

434: The source access layer API 4002 ends the procedure.

According to the method provided in some embodiments, after checking the mirror replication request, the source access layer sends the mirror meta-information replication request to the destination access layer, and after checking the mirror meta-information replication request, the destination access layer writes the mirror meta-information in the source database into the destination database, so that a standardized and product-level cross-region solution of the mirror meta-information is implemented, thereby improving the efficiency of cross-region replication of mirrors.

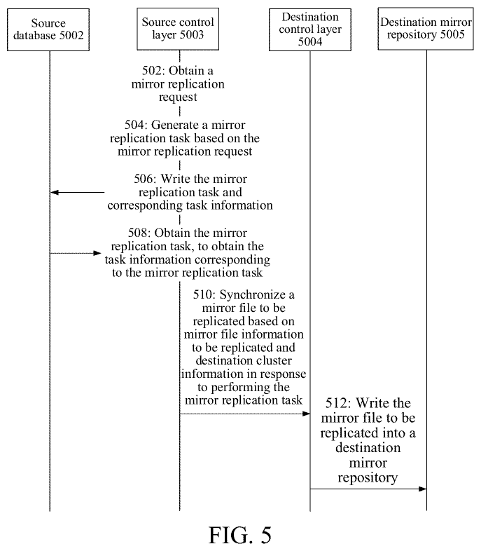

FIG. 5 is a schematic diagram of a process of operation 206 shown in FIG. 2 in some embodiments. As shown in FIG. 5, in some embodiments, 206 may further include the following operations 502 to 512.

502: A source control layer 5003 obtains a mirror replication request.

504: The source control layer 5003 generates a mirror replication task based on the mirror replication request.

506: The source control layer 5003 writes the mirror replication task and corresponding task information into a source database 5002, the task information corresponding to the mirror replication task including mirror file information to be replicated and destination cluster information.

In some embodiments, the task information corresponding to the mirror replication task may include a parameter of the mirror replication task. The mirror file information to be replicated may include an ID of a mirror file to be replicated, the destination cluster information may include an identification of a destination region, and the ID of the mirror file to be replicated and the identification of the destination region may be parameters of the mirror replication task.

In some embodiments, the mirror replication task and the parameter may be written into the source database. For example, when the source database is MySQL, a task table may be created, and the mirror replication task and the parameter are written into the task table.

In some embodiments, a source access layer may synchronize the mirror replication request a source control layer 5003 interface for processing, and operations 502 to 506 may be performed by the source control layer 5003 interface. For some embodiments, reference may be made to FIG. 14 to FIG. 16.

508: The source control layer 5003 obtains the mirror replication task from the source database 5002, to obtain the task information corresponding to the mirror replication task.

In some embodiments, during creation of the task table, a corresponding task execution parameter, for example, regular execution, may further be configured. The source control layer 5003 may regularly obtain the mirror replication task from the source database 5002, and perform the mirror replication task.

In some embodiments, the task information corresponding to the mirror replication task may include a task parameter, and the task parameter may include the ID of the mirror file to be replicated and the identification of the destination region.

In some embodiments, when the source database 5002 is MySQL, the source control layer 5003 may train a task table of the source database 5002 in rotation, to obtain an asynchronous task written by the source control layer 5003 interface.

510: The source control layer 5003 synchronizes the mirror file to be replicated to a destination control layer 5004 based on the mirror file information to be replicated and the destination cluster information in response to performing the mirror replication task.

In some embodiments, the source control layer 5003 may request, based on the identification of the destination region, the destination control layer 5004 to open a mirror synchronization port, to transfer the mirror file to be replicated, and close the port after the transfer is completed. For some embodiments, reference may be made to FIG. 7.

512: The destination control layer 5004 writes the mirror file to be replicated into a destination mirror repository 5005.

In some embodiments, the source control layer 5003 may download the mirror file to be replicated from a source mirror repository in real time, and transfer the mirror file to be replicated to the destination control layer 5004 through the port opened by the destination control layer 5004, and then the destination control layer 5004 transfers the mirror file to be replicated to the destination mirror repository 5005 in real time. For example, if a total size of the mirror file to be replicated is 5G, when the source control layer 5003 downloads 100M of the mirror file to be replicated from the source mirror repository, the source control layer 5003 also transfers the 100M of mirror file to be replicated to the destination control layer 5004 through the port opened by the destination control layer 5004 in real time, and the destination control layer 5004 also transfers the 100M of mirror file to be replicated to the destination mirror repository 5005 in real time. When all of the 5G of mirror file to be replicated is downloaded completely, all of the 5G of mirror file to be replicated may be written into the destination mirror repository 5005. A mirror replication time can be greatly reduced.

According to the method provided in some embodiments, the mirror replication task is generated based on the mirror replication request and written into the source database, and the mirror replication task is obtained from the source database for processing, to implement an asynchronous completion of importing of an image, thereby implementing the commercialization of the solution of cross-region replication of mirrors, and improving the efficiency of cross-region replication of mirrors.

FIG. 6 is a schematic diagram of a process of operation 510 shown in FIG. 5 in some embodiments. As shown in FIG. 6, in some embodiments, operation 510 may further include the following operations 602 to 606.

602: A source control layer 6002 invokes, based on destination cluster information in response to performing a mirror replication task, a destination control layer 6004 to open a mirror synchronization port.

In some embodiments, the source control layer 6002 may send a request for opening a mirror synchronization port to the destination control layer 6004 in response to performing the mirror replication task. The destination control layer 6004 may randomly open a mirror synchronization port in a target port range in response to the received request for opening a mirror synchronization port. For some embodiments, reference may be made to FIG. 7.

In some embodiments, the source control layer 6002 may request the destination control layer 6004 to open a target mirror synchronization port. For example, the request for opening a mirror synchronization port sent to the destination control layer 6004 by the source control layer 6002 may include an identification of the target mirror synchronization port requested to be opened, and the destination control layer 6004 may open the target mirror synchronization port in response to the received request for opening a target mirror synchronization port.

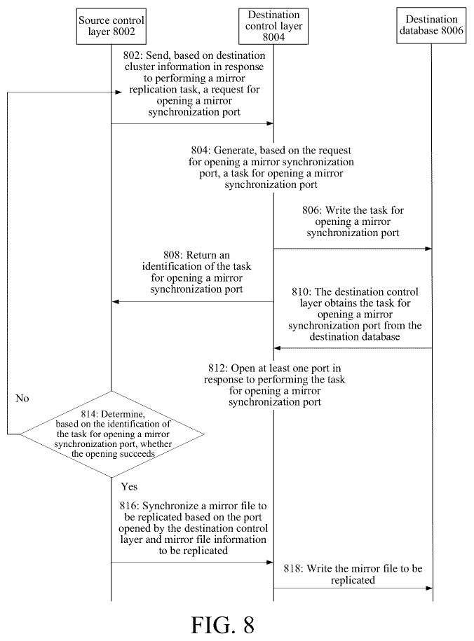

In some embodiments, the source control layer 6002 may send the request for opening a mirror synchronization port to the destination control layer 6004 in response to performing the mirror replication task. The destination control layer 6004 may generate a task for opening a mirror synchronization port based on the received request for opening a mirror synchronization port, and write the task for opening a mirror synchronization port into a destination database. The destination control layer 6004 obtains the task for opening a mirror synchronization port from the destination database, and performs the task for opening a mirror synchronization port. For some embodiments, reference may be made to FIG. 8.

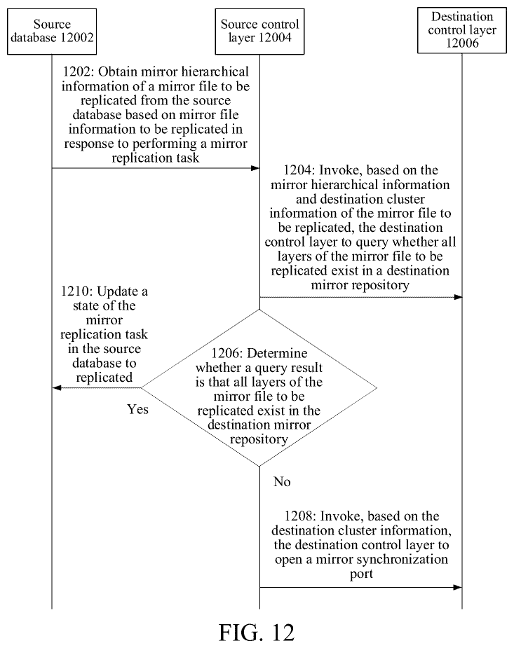

In some embodiments, before invoking the destination control layer 6004 to open the mirror synchronization port, the source control layer 6002 may determine, based on mirror hierarchical information, whether a mirror file to be replicated exists in a destination mirror repository. If the mirror file to be replicated exists in the destination mirror repository, the source control layer 6002 does not continue to perform the mirror replication task. If the mirror file to be replicated does not exist in the destination mirror repository, the source control layer 6002 performs the mirror replication task, and invokes the destination control layer 6004 to open the mirror synchronization port. For some embodiments, reference may be made to FIG. 12.

604: The source control layer 6002 synchronizes the mirror file to be replicated to the destination control layer 6004 based on the port opened by the destination control layer 6004 and mirror file information to be replicated.

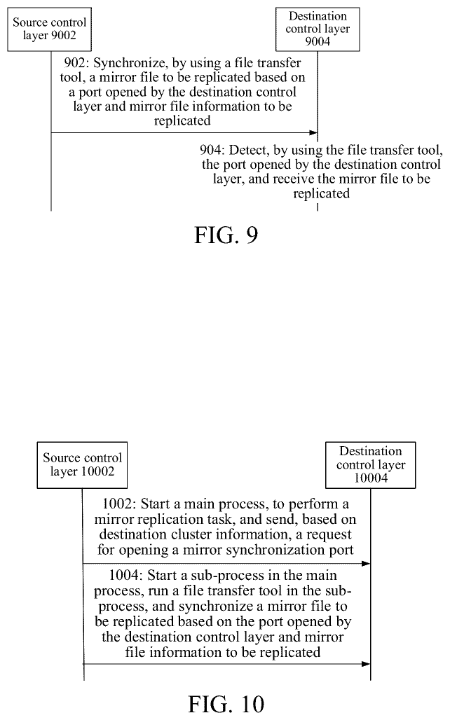

In some embodiments, a file transfer tool may be used to detect the port opened by the destination control layer 6004, to receive the mirror file to be replicated. For some embodiments, reference may be made to FIG. 9.

606: The source control layer 6002 invokes, based on the destination cluster information in response to determining that synchronization of the mirror file to be replicated is completed, the destination control layer 6004 to close the port opened by the destination control layer 6004.

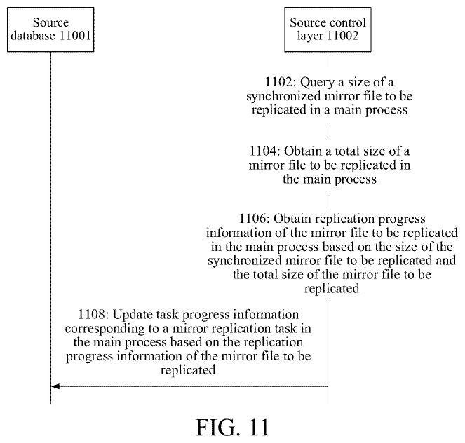

In some embodiments, the source control layer 6002 may determine that the synchronization of the mirror file to be replicated is completed when obtaining a mirror replication progress being 100%. For additional implementation details of the source control layer 6002 obtaining the mirror replication progress, reference may be made to FIG. 11.

In some embodiments, the source control layer 6002 may send a request for closing the opened mirror synchronization port to the destination control layer 6004, where the request may include an identification of the opened mirror synchronization port. The destination control layer 6004 closes the corresponding port based on the request.

According to the method provided in some embodiments, the source control layer performs the mirror replication task; requests, based on the identification of the destination region, the destination control layer to open the mirror synchronization port, to transfer the mirror file to be replicated; and closes the port after the transmission is completed, so that the port is opened only during synchronization of the mirror file to be replicated. The quantity of opened resident ports is reduced, the risk of attacks on the destination cluster server node is reduced, and the system reliability is improved.

FIG. 7 is a schematic diagram of a process of operation 602 shown in FIG. 6 in some embodiments. As shown in FIG. 7, in some embodiments, operation 602 may further include the following operations 702 to 704.

702: A source control layer 7002 sends, based on destination cluster information in response to performing a mirror replication task, a request for opening a mirror synchronization port to a destination control layer 7004.

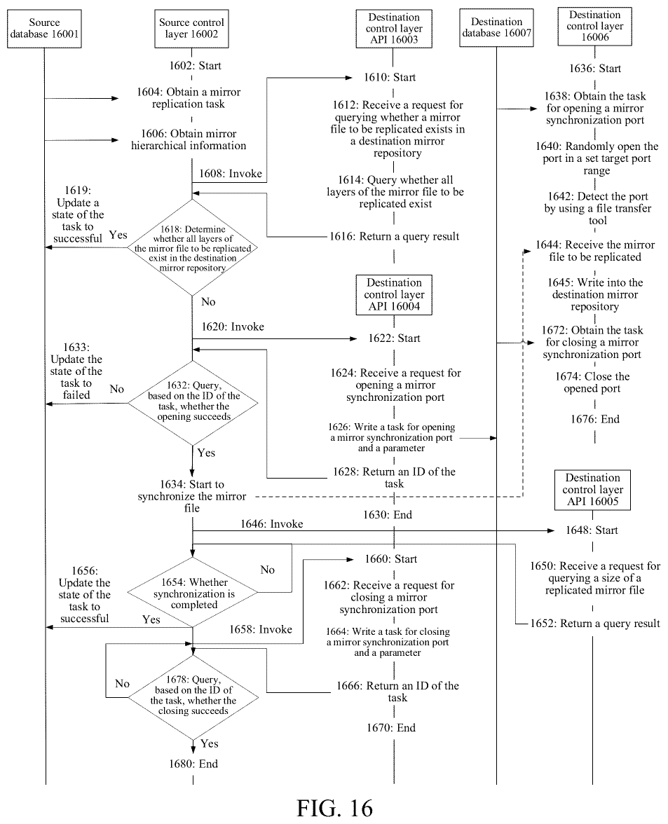

In some embodiments, the destination control layer 7004 may include a destination control layer interface. The source control layer 7002 may send, in response to performing the mirror replication task, the request for opening a mirror synchronization port to the destination control layer interface based on an IP address of a destination cluster associated with an identification of a destination region in the destination cluster information. The destination control layer interface may receive the request from the source control layer by providing an http service. For a procedure implemented by the destination control layer interface, reference may be made to FIG. 16.

704: The destination control layer 7004 randomly opens at least one port in a target port range based on the request for opening a mirror synchronization port.

In some embodiments, the destination control layer 7004 may randomly open a detectable port based on a preset target port range in response to the request for opening a mirror synchronization port. For example, the target port range may be in a range of 50000 to 50200, or in a range of 60000 to 60100, or in a range of 60000 to 60100. Each mirror replication task occupies one port. For example, when the target port range is in the range of 60000 to 60100, up to 100 mirrors can be simultaneously synchronized.

According to the method provided in some embodiments, the source control layer sends the request for opening a mirror synchronization port to the destination control layer in response to performing the mirror replication task, and in response to the received request for opening a mirror synchronization port, the destination control layer randomly opens the mirror synchronization port in the target port range for the current mirror replication task, so that a maximum quantity of mirror replication tasks can be restricted based on the design of the target port range, thereby improving the availability of the solution of cross-region replication of mirrors.

FIG. 8 is a schematic diagram of a process of operation 602 shown in FIG. 6 in some embodiments. As shown in FIG. 8, in some embodiments, operation 602 may further include the following operations 802 to 818.

802: A source control layer 8002 sends, based on destination cluster information in response to performing a mirror replication task, a request for opening a mirror synchronization port to a destination control layer 8004.

In some embodiments, for additional implementation details of operation 802, reference may be made to operation 602.

In some embodiments, the mirror replication task may be performed in a main process, to send the request for opening a mirror synchronization port, and after it is determined that the mirror synchronization port is opened, another sub-process is started to synchronize a mirror file to be replicated by using a file transfer tool. For some embodiments, reference may be made to FIG. 10.

804: A destination control layer 8004 generates, based on the request for opening a mirror synchronization port, a task for opening a mirror synchronization port.

In some embodiments, a destination control layer 8004 interface that receives the request for opening a mirror synchronization port may perform validity check on the request. For example, if the source control layer 8002 requests the destination control layer 8004 to open a target mirror synchronization port, the request for opening a mirror synchronization port may be parsed to obtain an identification of the target mirror synchronization port requested to be opened, and then whether the obtained identification of the target mirror synchronization port is within a preset target port range may be checked. If the identification of the target mirror synchronization port is within the preset target port range, the validity check succeeds, and the corresponding task for opening a mirror synchronization port is generated; otherwise, the validity check may fail, the procedure ends, the source control layer 8002 is prompted, in a return value of the request for opening a mirror synchronization port, that the mirror synchronization port is not opened, and the source control layer 8002 may determine, in operation 814, that the mirror synchronization port fails to be opened.

806: The destination control layer 8004 writes the task for opening a mirror synchronization port into a destination database 8006.

In some embodiments, when the destination database 8006 is MySQL, the destination control layer 8004 interface may write the task for opening a mirror synchronization port and a parameter into a task table.

808: the destination control layer 8004 returns an identification of the task for opening a mirror synchronization port.

In some embodiments, after the task for opening a mirror synchronization port is successfully written, the destination control layer 8004 may return the identification of the task for opening a mirror synchronization port to the source control layer 8002, and use the identification as the return value of the request for opening a mirror synchronization port, so that the source control layer 8002 determines that the mirror synchronization port is (soon to be) opened and ready to transfer the mirror file to be replicated.

810: The destination control layer 8004 obtains the task for opening a mirror synchronization port from the destination database 8006.

812: The destination control layer 8004 opens at least one port in response to performing the task for opening a mirror synchronization port.

In some embodiments, the destination control layer 8004 may randomly open at least one port in the target port range in response to performing the task for opening a mirror synchronization port. For example, the target port range may be in a range of 50000 to 50200, or in a range of 60000 to 60100, or in a range of 60000 to 60100, and the destination control layer 8004 randomly opens a detectable port in the preset target port range.

In some embodiments, the parameter of the task for opening a mirror synchronization port may include the identification of the target mirror synchronization port requested to be opened, and the destination control layer 8004 may open the target mirror synchronization port in response to performing the task for opening a mirror synchronization port.

814: The source control layer 8002 determines, based on the identification of the task for opening a mirror synchronization port, whether the opening succeeds.

In some embodiments, if obtaining the identification of the task for opening a mirror synchronization port in the return value of the request for opening a mirror synchronization port sent to the destination control layer 8004, the source control layer 8002 may determine that the mirror synchronization port is successfully opened. If the identification of the task for opening a mirror synchronization port is not obtained, it may be determined that the mirror synchronization port is not successfully opened. If it is determined that the mirror synchronization port is not successfully opened, perform operation 802.

816: If it is determined that the mirror synchronization port is successfully opened, the source control layer 8002 synchronizes the mirror file to be replicated to the destination control layer 8004 based on the port opened by the destination control layer 8004 and mirror file information to be replicated.

In some embodiments, the file transfer tool may be used to detect the port opened by the destination control layer 8004, to receive the mirror file to be replicated. For some embodiments, reference may be made to FIG. 9.

818: The destination control layer 8004 writes the mirror file to be replicated into a destination mirror repository.

According to the method provided in some embodiments, the source control layer sends the request for opening a mirror synchronization port to the destination control layer in response to performing the mirror replication task. The destination control layer generates the task for opening a mirror synchronization port based on the received request for opening a mirror synchronization port, and writes the task for opening a mirror synchronization port into the destination database. The destination control layer obtains the task for opening a mirror synchronization port from the destination database, and performs the task for opening a mirror synchronization port, to perform the request for opening a mirror synchronization port and the task for opening a mirror synchronization port asynchronously, thereby is implementing the commercialization of the solution of cross-region replication of mirrors, and improving the efficiency of cross-region replication of mirrors.

According to the method provided in some embodiments, mirror file transfer between the source control layer and the destination control layer by using an ip+port file transfer tool. In a cloud native deployment, a network may be configured to use a host mode (for example, a configuration command may be—network=host) when containers of the source control layer and the destination control layer are started. The containers on the control layers do not virtualize their own network adapter, configure their own ip, or the like, but uses an ip of a cluster host computer. Cluster host computers may access each other through intranet interconnection. The containers of the source control layer and the destination control layer can access each other, that is, ips of the source control layer and the destination control layer can access each other. Compared with a physical machine cluster that may use dedicated lines for cross-region network access, cross-region network access implementations can be facilitated for the cloud native deployment.

FIG. 9 is a schematic diagram of a process of operation 816 shown in FIG. 8 in some embodiments. As shown in FIG. 9, in some embodiments, operation 816 may further include the following operations 902 to 904.

902: A source control layer 9002 synchronizes, by using a file transfer tool, a mirror file to be replicated based on a port opened by a destination control layer 9004 and mirror file information to be replicated.

In some embodiments, the source control layer 9002 may start to synchronize, by using the file transfer tool, the mirror file to be replicated based on the port opened by the destination control layer. For example, the file transfer tool may be an open source tool such as netcat or rsync. Using netcat as an example, a file synchronization command may be:
cat imgfile|nc ip port

In some embodiments, a mirror replication task may be performed in a main process, to send a request for opening a mirror synchronization port, and after it is determined that the mirror synchronization port is opened, another sub-process is started to synchronize a mirror file to be replicated by using the file transfer tool. For some embodiments, reference may be made to FIG. 10.

904: The destination control layer 9004 detects, by using the file transfer tool, the port opened by the destination control layer 9004, and receives the mirror file to be replicated.

In some embodiments, the destination control layer 9004 may detect, by using the file transfer tool, a port that is currently opened by the destination control layer. For example, the file transfer tool may be an open source tool such as netcat or rsync. Using netcat as an example, and a command at the destination control layer 9004 may be:
nc-4-1 port>img.file

According to the method provided in some embodiments, the mirror file to be replicated is transferred, by using the file transfer tool, from the source control layer to the detectable port opened by the destination control layer, thereby implementing the commercialization of the solution of cross-region replication of mirrors is, and improving the efficiency of cross-region replication of mirrors.

FIG. 10 is a schematic diagram of a process of operation 802 shown in FIG. 8 and operation 902 shown in FIG. 9 in some embodiments. As shown in FIG. 10, in some embodiments, operation 902 may further include the following operation 1002, and operation 904 may further include the following operation 1004.

1002: A source control layer starts a main process, to perform a mirror replication task, and sends a request for opening a mirror synchronization port to a destination control layer based on destination cluster information.

1004: The source control layer starts a sub-process in the main process, runs the file transfer tool in the sub-process, and synchronizes the mirror file to be replicated based on the port opened by the destination control layer and the mirror file information to be replicated.

According to the method provided in some embodiments, the mirror replication task is performed in the main process, to send the request for opening a mirror synchronization port, and after it is determined that the mirror synchronization port is opened, another sub-process is started to synchronize the mirror file to be replicated by using the file transfer tool. A plurality of mirror files to be replicated can be synchronized in parallel in a plurality of sub-processes. If another request continues to be responded or generated in the main process, synchronization of the mirror files to be replicated in the sub-processes is not affected, thereby improving the success rate and reliability of the solution cross-region replication of mirrors.

FIG. 11 is a flowchart of a method according to some embodiments. As shown in FIG. 11, the method may further include the following operations 1102 to 1108, to obtain a replication progress of a mirror file to be replicated.

1102: A source control layer 11002 queries a size of a synchronized mirror file to be replicated in a main process.

In some embodiments, the source control layer 11002 may invoke a destination control layer interface in the main process, to request to query the size of the synchronized mirror file to be replicated. The destination control layer interface may obtain the size of the synchronized mirror file to be replicated from a destination mirror repository, and then return the size of the synchronized mirror file to be replicated to a source control layer interface.

1104: The source control layer 11002 obtains a total size of the mirror file to be replicated in the main process.

In some embodiments, the source control layer may obtain the total size of the mirror file to be replicated from a source database 11001 in the main process based on an identification of the mirror file to be replicated.

In some embodiments, a task parameter of a mirror replication task may further include the total size of the mirror file to be replicated, which may be obtained from the source database 11001 by the source control layer 11002 when the mirror replication task is generated.

1106: The source control layer 11002 obtains replication progress information of the mirror file to be replicated in the main process based on the size of the synchronized mirror file to be replicated and the total size of the mirror file to be replicated.

In some embodiments, the size of the synchronized mirror file to be replicated may be divided by the total size of the mirror file to be replicated, to obtain the replication progress information of the mirror file to be replicated. For example, if it is obtained that the size of the synchronized mirror file to be replicated is 500M, and the total size of the mirror file to be replicated is 1G, it may be obtained that the replication progress information of the mirror file to be replicated is 50%.

1108: The source control layer 11002 updates task progress information corresponding to the mirror replication task in the source database 11001 in the main process based on the replication progress information of the mirror file to be replicated.

In some embodiments, a state of each mirror replication task in the source database 11001 may be read in real time at a console, and a replication progress of each mirror file to be replicated is obtained through the state of each mirror replication task.

According to the method provided in some embodiments, the sub-process is started to synchronize the mirror file to be replicated, and the size of the mirror file to be replicated that is replicated is asynchronously queried in the main process. A mirror replication progress is calculated based on the total size of the mirror file to be replicated, and a task progress may be regularly updated to the source database, so that a user can obtain the replication progress of each mirror file to be replicated at the console through a source access layer, thereby improving the user experience.

FIG. 12 is a schematic diagram of a process of operation 602 shown in FIG. 6 in some embodiments. As shown in FIG. 12, in some embodiments, operation 602 may further include the following operations 1202 to 1210.

1202: A source control layer 12004 obtains mirror hierarchical information of a mirror file to be replicated from a source database 12002 based on mirror file information to be replicated in response to performing a mirror replication task.

In some embodiments, the source control layer 12004 may obtain the mirror hierarchical information of the mirror file to be replicated from the source database 12002 based on an ID of the mirror file to be replicated in the mirror file information to be replicated. Using a private cloud environment as an example, the mirror file to be replicated may be divided into a base-layer mirror and a second-layer mirror.

1204: The source control layer 12004 invokes, based on the mirror hierarchical information of the mirror file to be replicated and the destination cluster information, the destination control layer 12006 to query whether all layers of the mirror file to be replicated exist in the destination mirror repository.

Using the private cloud environment as an example, the source control layer 12004 may invoke the destination control layer 12006 to query whether the base-layer mirror and the second-layer mirror of the mirror file to be replicated exist in the destination mirror repository.

1206: The source control layer 12004 obtains a query result of the destination control layer 12006, and determines whether the query result is that all layers of the mirror file to be replicated exist in the destination mirror repository.

1208: If the query result obtained by the source control layer 12004 is that not all layers of the mirror file to be replicated exist in the destination mirror repository, invoke, based on the destination cluster information, the destination control layer 12006 to open a mirror synchronization port.

1210: If the query result obtained by the source control layer 12004 is that all layers of the mirror file to be replicated exist in the destination mirror repository, update a state of the mirror replication task in the source database 12002 to replicated.

According to the method provided in some embodiments, before invoking the destination control layer 12006 to open the mirror synchronization port, the source control layer 12004 determines, based on the mirror hierarchical information, whether the mirror file to be replicated exists in the destination mirror repository. If the mirror file to be replicated exists in the destination mirror repository, the source control layer 12004 does not continue to perform the mirror replication task. If the mirror file to be replicated does not exist in the destination mirror repository, the source control layer 12004 continues to perform the mirror replication task, and invokes the destination control layer 12006 to open the mirror synchronization port, so that repeated execution of the same mirror replication task can be avoided, thereby improving the efficiency of cross-region replication of mirrors.

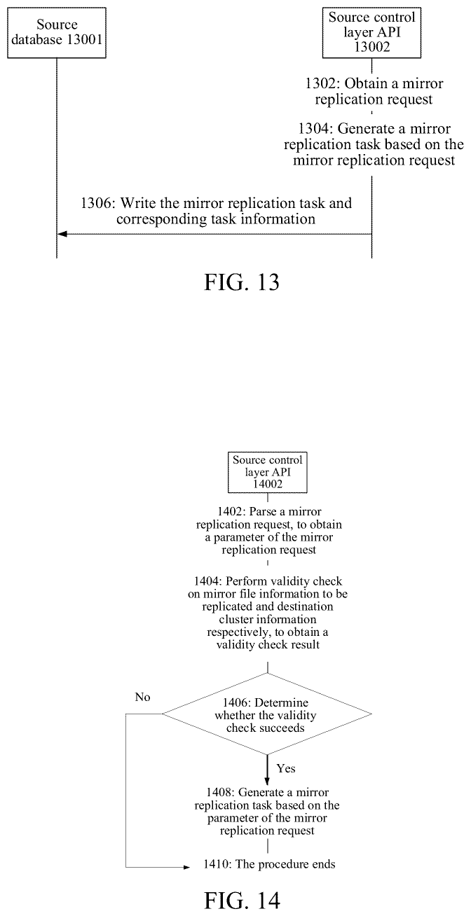

FIG. 13 is a schematic diagram of a process of operation 502 to 506 shown in FIG. 5 in some embodiments. As shown in FIG. 13, in some embodiments, operation 502 may further include the following operation 1302, operation 504 may further include the following operation 1304, and operation 506 may further include the following operation 1306.

1302: A source control layer interface 13002 obtains a mirror replication request.

In some embodiments, a source access layer may synchronize the mirror replication request to the source control layer interface 13002.

1304: The source control layer interface 13002 generates a mirror replication task based on the mirror replication request.

In some embodiments, the source control layer interface 13002 may perform validity check on a parameter of the mirror replication request, and generate the corresponding mirror replication task after the check succeeds. For some embodiments, reference may be made to FIG. 15.

1306: The source control layer interface 13002 writes the mirror replication task and corresponding task information into a source database 13001.

In some embodiments, the task information corresponding to the mirror replication task may be a task parameter. When the source database 13001 is MySQL, the source control layer interface may write the mirror replication task and the parameter into a task table.

According to the method provided in some embodiments, the source control layer interface is set for the source control layer, parsing the mirror replication request and generating the mirror replication task may be based on a parsing result and writing the mirror replication task, and obtaining and performing the mirror replication task may be decoupled, so that the reliability of the solution cross-region replication of mirrors in a source cluster can be improved.

FIG. 14 is a schematic diagram of a process of operation 1304 shown in FIG. 13 in some embodiments. As shown in FIG. 14, in some embodiments, operation 1304 may further include the following operations 1402 to 1410. A procedure shown in FIG. 14 may be implemented by a source control layer interface 14002.

1402: Parse a mirror replication request, to obtain a parameter of the mirror replication request, the parameter of the mirror replication request including mirror file information to be replicated and destination cluster information.

1404: Perform validity check on the mirror file information to be replicated and the destination cluster information respectively, to obtain a validity check result.

1406: Determine whether the validity check result indicates that the validity check succeeds.

In some embodiments, a manner of performing validity check on the parameter of the mirror replication request by the source control layer interface may be the same as that by an access layer. For some embodiments, reference may be made to 406.

In some embodiments, the source control layer interface may further read mirror meta-information of a mirror file to be replicated from a database for checking, for example, validity of a mirror arch version and validity of a mirror version.

1408: The source control layer interface generates a mirror replication task based on the parameter of the mirror replication request if the validity check result indicates that the validity check succeeds.

1410: The procedure ends if the validity check result indicates that the validity check fails.

According to the method provided in some embodiments, the source control layer interface checks the mirror replication request after parsing the mirror replication request, and generates the corresponding mirror replication task after the checking succeeds, so that writing of invalid data into the source database can be avoided, and operations of some incorrect requests can also be blocked, thereby improving the reliability of the solution of cross-region replication of mirrors.

FIG. 15 is a schematic flowchart of a source control layer interface generating a mirror replication task according to FIG. 13 and FIG. 14. Some embodiments shown in FIG. 15 may include the following operations 1502 to 1512.

1502: Start.

1504: Receive a mirror replication request.

1506: Check whether a parameter of the mirror replication request is valid. If a check result is invalid, perform operation 1512 to end the procedure.

1508: If the check result is valid, generate a mirror replication task based on the mirror replication request, and write the mirror replication task and a parameter into a source database.

1510: Determine whether the writing succeeds. If the writing fails, perform 1508 for re-writing.

1512: The procedure ends if the writing succeeds.

According to the method for implementing the source control layer interface provided in some embodiments, the corresponding mirror replication task is generated after the check of the mirror replication request succeeds, whether the writing succeeds is determined after the operation of writing into the source database, and the writing is re-performed if the writing fails, so that the loss of the task written into the source database can be avoided, thereby improving the reliability of the solution of cross-region replication of mirrors.

FIG. 16 is a schematic flowchart of a source control layer processing a mirror replication task according to FIG. 2 to FIG. 12. A standardized and product-level mirror replication task processing procedure shown in FIG. 16 may include the following operation 1602 to 1680.

1602: A source control layer 16002 starts a procedure.

1604: The source control layer 16002 obtains a mirror replication task from a source database 16001.

1606: The source control layer 16002 obtains mirror hierarchical information from the source database 16001.

1608: The source control layer 16002 invokes a destination control layer API 16003 to query, based on the obtained mirror hierarchical information, whether a mirror file to be replicated exists in a destination mirror repository.

1610: The destination control layer API 16003 starts the procedure.

1612: The destination control layer API 16003 receives a request for querying whether the mirror file to be replicated exists in the destination mirror repository that is sent by the source control layer 16002.

1614: The destination control layer API 16003 queries, based on the request, whether all layers of the mirror file to be replicated exist in the destination mirror repository.

1616: The destination control layer API 16003 returns a query result to the source control layer 16002.

1618: The source control layer 16002 determines, based on the returned query result, whether all layers of the mirror file to be replicated exist in the destination mirror repository.

1619: If all layers of the mirror file to be replicated exist in the destination mirror repository, the source control layer 16002 updates a state of the mirror replication task in the source database 16001 to successful.

1620: If not all layers of the mirror file to be replicated exist in the destination mirror repository, invoke a destination control layer API 16004 to open a mirror synchronization port.

1622: The destination control layer API 16004 starts the procedure.

1624: The destination control layer API 16004 receives a request for opening a mirror synchronization port.

1626: The destination control layer API 16004 generates, based on the request for opening a mirror synchronization port, a task for opening a mirror synchronization port, and writes the task for opening a mirror synchronization port and a parameter into a destination database 16007.

1628: The destination control layer API 16004 returns an ID of the task for opening a mirror synchronization port to the source control layer 16002.

1630: The destination control layer API 16004 ends the procedure.

1632: The source control layer 16002 queries, based on the ID of the task for opening a mirror synchronization port that is returned by the destination control layer API 16004, whether the mirror synchronization port is successfully opened.

1633: If the source control layer 16002 determines that the mirror synchronization port is unsuccessfully opened, update the state of the mirror replication task in the source database 16001 to failed.

1634: If the source control layer 16002 determines that the mirror synchronization port is successfully opened, invoke a destination control layer 16006 to synchronize the mirror file to be replicated by using the opened port.

1636: The destination control layer 16006 starts the procedure.

1638: The destination control layer 16006 obtains the task for opening a mirror synchronization port from the destination database 16007.

1640: The destination control layer 16006 performs the task for opening a mirror synchronization port, to randomly open at least one port in a set target port range.

1642: The destination control layer 16006 detects the opened port by using a file transfer tool.

1644: The destination control layer 16006 receives the mirror file to be replicated by using the file transfer tool.

1645: The destination control layer 16006 writes the received mirror file to be replicated into the destination mirror repository.

1646: The source control layer 16002 invokes a destination control layer API 16005 to query a mirror replication progress.

1648: The destination control layer API 16005 starts the procedure.

1650: The destination control layer API 16005 receives a request for querying a size of a replicated mirror file to be replicated that is sent by the source control layer 16002.

1652: The destination control layer API 16005 returns a query result to the source control layer 16002.

1654: The source control layer 16002 determines, based on the query result returned by the destination control layer API 16005, whether synchronization of the mirror file to be replicated is completed.

1656: If the synchronization of the mirror file to be replicated is completed, the source control layer 16002 updates the state of the mirror replication task in the source database 16001 to successful. If the synchronization of the mirror file to be replicated is not completed, perform operation 1654 regularly again until the synchronization is completed.

1658: If the synchronization of the mirror file to be replicated is completed, the source control layer 16002 invokes the destination control layer API 16004 to close the opened mirror synchronization port.

1660: The destination control layer API 16004 starts the procedure.

1662: The destination control layer API 16004 receives a request for closing a mirror synchronization port that is sent by the source control layer 16002.

1664: The destination control layer API 16004 generates, based on the request, a task for closing a mirror synchronization port, and writes the task for closing a mirror synchronization port and a parameter into the destination database 16007.

1666: The destination control layer API 16004 returns an ID of the task for closing a mirror synchronization port to the source control layer 16002.

1670: The destination control layer API 16004 ends the procedure.

1672: The destination control layer 16006 obtains the task for closing a mirror synchronization port from the destination database 16007.

1674: The destination control layer 16006 performs the task for closing a mirror synchronization port, to close the opened mirror synchronization port.

1676: The destination control layer 16006 ends the procedure.

1678: The source control layer 16002 queries, based on the ID of the task for closing a mirror synchronization port that is returned by the destination control layer API 16004, whether the mirror synchronization port is successfully closed. If the mirror synchronization port is not successfully closed, perform operation 1658.

1680: If the mirror synchronization port is successfully closed, the source control layer 16002 ends the procedure.

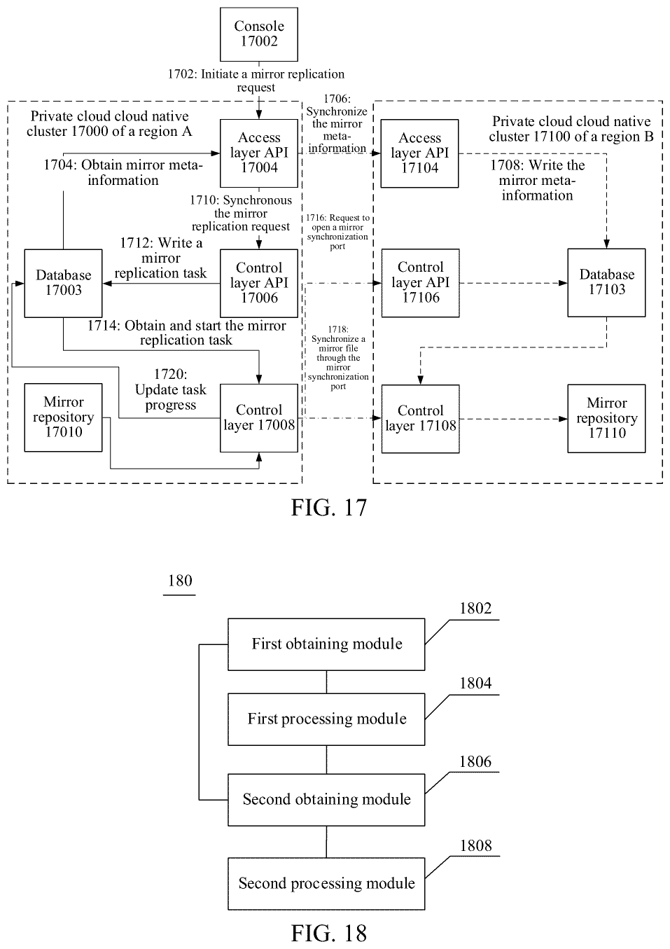

FIG. 17 is a schematic flowchart of cross-region replication of mirrors in a scenario of a cloud native cluster of a private cloud according to FIG. 2 to FIG. 16. A procedure of cross-region replication of mirrors shown in FIG. 17 may include the following operations 1702 to 1720, to synchronize a mirror file to be replicated in a cloud native cluster of a private cloud 17000 of a region A to a cloud native cluster of a private cloud 17100 of a region B. The cloud native cluster of a private cloud 17000 of the region A may include a database 17003 and a mirror repository 17010, and may be provided with an access layer API 17004, a control layer API 17006, and a control layer 17008. The cloud native cluster of a private cloud 17100 of the region B may include a database 17103 and a mirror repository 17110, and may be provided with an access layer API 17104, a control layer API 17106, and a control layer 17108.

1702: A console 17002 initiates a mirror replication request.

1704: The access layer API 17004 in the cloud native cluster of a private cloud 17000 of the region A receives the mirror replication request, and obtains mirror meta-information from the database 17003.

1706: The access layer API 17004 synchronizes the mirror meta-information to the access layer API 17104 in the cloud native cluster of a private cloud 17100 of the region B.

1708: The access layer API 17104 writes the mirror meta-information into the database 17103 in the cloud native cluster of a private cloud 17100 of the region B.

1710: The access layer API 17004 synchronizes the received mirror replication request to the control layer API 17006.

1712: The control layer API 17006 generates a mirror replication task based on the mirror replication request, and writes the mirror replication task into the database 17003.

1714: The control layer 17008 obtains the mirror replication task from the database 17003, and starts to perform the mirror replication task.

1716: The control layer 17008 invokes the control layer API 17106 in the cloud native cluster of a private cloud 17100 of the region B, to request to open a mirror synchronization port.

1718: The control layer 17008 synchronizes the mirror file to be replicated in the mirror repository 17010 to the control layer 17108 in the cloud native cluster of a private cloud 17100 of the region B through the opened mirror synchronization port, so that the control layer 17108 writes the mirror file to be replicated into the mirror repository 17110 in the cloud native cluster of a private cloud 17100 of the region B.

1720: The control layer 17008 updates a task progress in the database 17003.

FIG. 18 is a block diagram of a mirror processing apparatus according to some embodiments. The apparatus shown in FIG. 18 may be applied to, for example, a cloud server or a terminal device in the foregoing system.

The apparatus shown in FIG. 18 may be arranged in a source cluster deployed in a source region. The source cluster may be deployed with a source access layer and a source control layer, a source mirror repository stores a mirror file to be replicated, and a source database stores mirror meta-information of the mirror file to be replicated.

Referring to FIG. 18, the apparatus 180 provided in some embodiments may include a first obtaining module 1802, a first processing module 1804, a second obtaining module 1806, and a second processing module 1808.

The first obtaining module 1802 may be configured to obtain, by the source access layer, a mirror replication request, the mirror replication request including mirror file information to be replicated and destination cluster information, the destination cluster information corresponding to a destination cluster, the destination cluster being deployed in a destination region, the destination region being different from the source region, and the destination cluster being deployed with a destination access layer and a destination control layer.

The first processing module 1804 may be configured to: replicate, by the source access layer, the mirror meta-information in the source database to a destination database through the destination access layer based on the mirror replication request, the mirror file information to be replicated, and the destination cluster information.

The first processing module 1804 may be further configured to: obtain, by the source access layer, the mirror meta-information from the source database based on the mirror file information to be replicated; and synchronize, by the source access layer, the mirror meta-information to the destination access layer based on the destination cluster information, to write the mirror meta-information into the destination database through the destination access layer.

The second obtaining module 1806 may be configured to obtain, by the source control layer, a mirror replication request.

The second processing module 1808 may be configured to: replicate, by the source control layer, the mirror file to be replicated in the source mirror repository to a destination mirror repository through the destination control layer based on the mirror replication request, the mirror file information to be replicated, and the destination cluster information.

The second processing module 1808 may be further configured to: generate, by the source control layer, a mirror replication task based on the mirror replication request; write, by the source control layer, the mirror replication task and corresponding task information into the source database, the task information corresponding to the mirror replication task including the mirror file information to be replicated and the destination cluster information; obtain, by the source control layer, the mirror replication task from the source database; obtain the task information corresponding to the mirror replication task; and synchronize, by the source control layer, the mirror file to be replicated to the destination control layer based on the mirror file information to be replicated and the destination cluster information in response to performing the mirror replication task, to write, by the destination control layer, the mirror file to be replicated into the destination mirror repository.

The second processing module 1808 may be further configured to: invoke, by the source control layer based on the destination cluster information in response to performing the mirror replication task, the destination control layer to open a mirror synchronization port; synchronize, by the source control layer, the mirror file to be replicated to the destination control layer based on the port opened by the destination control layer and the mirror file information to be replicated, to write, by the destination control layer, the mirror file to be replicated into the destination mirror repository; and invoke, by the source control layer based on the destination cluster information in response to determining that synchronization of the mirror file to be replicated is completed, the destination control layer to close the port opened by the destination control layer.

The second processing module 1808 may be further configured to: send, by the source control layer, a request for opening a mirror synchronization port to the destination control layer based on the destination cluster information in response to performing the mirror replication task, to randomly open, by the destination control layer, at least one port in a target port range based on the request for opening a mirror synchronization port.

The second processing module 1808 may be further configured to: send, by the source control layer, the request for opening a mirror synchronization port to the destination control layer based on the destination cluster information in response to performing the mirror replication task, to generate, by the destination control layer based on the request for opening a mirror synchronization port, a task for opening a mirror synchronization port, write the task for opening a mirror synchronization port into the destination database, return an identification of the task for opening a mirror synchronization port, obtain the task for opening a mirror synchronization port from the destination database, and open at least one port in response to performing the task for opening a mirror synchronization port; and the second processing module is further configured to: determine, by the source control layer, based on the identification of the task for opening a mirror synchronization port, whether the opening succeeds; and synchronize, by the source control layer, if it is determined that the opening succeeds, the mirror file to be replicated to the destination control layer based on the port opened by the destination control layer and the mirror file information to be replicated, to write, by the destination control layer, the mirror file to be replicated into the destination mirror repository.

The second processing module 1808 may be further configured to: synchronize, by the source control layer, the mirror file to be replicated by using a file transfer tool based on the port opened by the destination control layer and the mirror file information to be replicated, to detect the port opened by the destination control layer, receive the mirror file to be replicated, and write, by the destination control layer, the mirror file to be replicated into the destination mirror repository by using the file transfer tool.

The second processing module 1808 may be further configured to: start, by the source control layer, a main process, to perform the mirror replication task, invoke, based on the destination cluster information, the destination control layer to open the mirror synchronization port, start, by the source control layer, a sub-process in the main process, run the file transfer tool in the sub-process, and synchronize the mirror file to be replicated based on the port opened by the destination control layer and the mirror file information to be replicated.

The second processing module 1808 may be further configured to: query, by the source control layer, a size of a synchronized mirror file to be replicated in the main process; obtain, by the source control layer, a total size of the mirror file to be replicated; obtain, by the source control layer, replication progress information of the mirror file to be replicated based on the size of the synchronized mirror file to be replicated and the total size of the mirror file to be replicated; and update, by the source control layer, task progress information corresponding to the mirror replication task in the source database based on the replication progress information of the mirror file to be replicated.

The second processing module 1808 may be further configured to: obtain, by the source control layer, mirror hierarchical information of the mirror file information to be replicated from the source database based on the mirror file information to be replicated in response to performing the mirror replication task; invoke, by the source control layer based on the mirror hierarchical information of the mirror file to be replicated and the destination cluster information, the destination control layer to query whether all layers of the mirror file to be replicated exist in the destination mirror repository; obtain, by the source control layer, a query result from the destination control layer; and if the source control layer determines, based on the query result, that not all layers of the mirror file to be replicated exist in the destination mirror repository, invoke, by the source control layer based on the destination cluster information, the destination control layer to open a mirror synchronization port to-be-replicated.

The second processing module 1808 may be further configured to: obtain, by the source control layer interface, the mirror replication request from the source access layer; generate, by the source control layer interface, the mirror replication task based on the mirror replication request; and write, by the source control layer interface, the mirror replication task and the corresponding task information into the source database.

The second processing module 1808 may be further configured to: parse, by the source control layer interface, the mirror replication request, to obtain a parameter of the mirror replication request, the parameter of the mirror replication request including the mirror file information to be replicated and the destination cluster information; perform, by the source control layer interface, validity check on the mirror file information to be replicated and the destination cluster information respectively, to obtain a validity check result; and generate, by the source control layer interface, the mirror replication task based on the parameter of the mirror replication request if the validity check result indicates that the validity check succeeds.

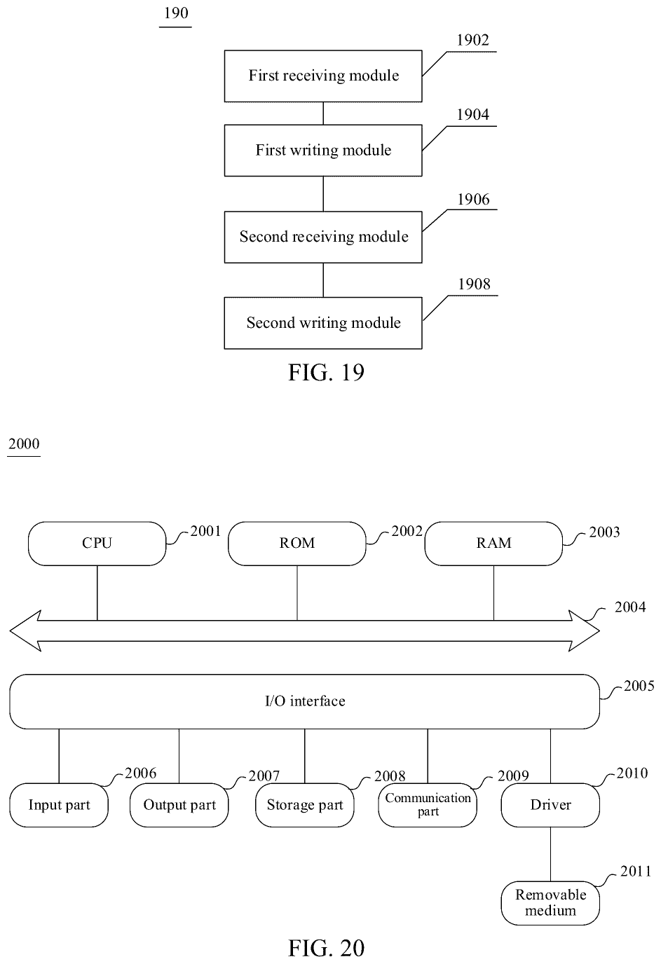

FIG. 19 is a block diagram of a mirror processing apparatus according to some embodiments. The apparatus shown in FIG. 19 may be applied to, for example, a cloud server or a terminal device in the foregoing system.

The apparatus shown in FIG. 19 may be arranged in a destination cluster deployed in a destination region, and the destination cluster may be deployed with a destination access layer and a destination control layer.

Referring to FIG. 19, the apparatus 190 provided in some embodiments may include a first receiving module 1902, a first writing module 1904, a second receiving module 1906, and a second writing module 1908.

The first receiving module 1902 may be configured to: receive, by the destination access layer, mirror meta-information of a mirror file to be replicated from a source access layer of a source cluster, the source cluster being deployed in a source region, the source region being different from the destination region, the source cluster being deployed with the source access layer and a source control layer, a source mirror repository storing the mirror file to be replicated, and a source database storing the mirror meta-information.

The first writing module 1904 may be configured to write, by the destination access layer, the mirror meta-information into a destination database.

The second receiving module 1906 may be configured to receive, by the destination control layer, the mirror file to be replicated from the source control layer.

The second writing module 1908 may be configured to write, by the destination control layer, the mirror file to be replicated into a destination mirror repository.

According to some embodiments, each module may exist respectively or be combined into one or more modules. Some modules may be further split into multiple smaller function subunits, thereby implementing the same operations without affecting the technical effects of some embodiments. The modules are divided based on logical functions. In actual applications, a function of one module may be realized by multiple modules, or functions of multiple modules may be realized by one module. In some embodiments, the apparatus may further include other modules. In actual applications, these functions may also be realized cooperatively by the other modules, and may be realized cooperatively by multiple modules.

A person skilled in the art would understand that these “modules” could be implemented by hardware logic, a processor or processors executing computer software code, or a combination of both. The “modules” may also be implemented in software stored in a memory of a computer or a non-transitory computer-readable medium, where the instructions of each module are executable by a processor to thereby cause the processor to perform the respective operations of the corresponding module.

In some embodiments, a mirror processing apparatus is provided. The apparatus is deployed in a source cluster of a source region. The apparatus includes a source access layer and a source control layer, the source cluster being deployed with a source mirror repository and a source database, the source mirror repository storing a mirror file to be replicated, and the source database storing mirror meta-information of the mirror file to be replicated.

The source access layer is configured to: obtain a mirror replication request, the mirror replication request including mirror file information to be replicated and destination cluster information, the destination cluster information corresponding to a destination cluster, the destination cluster being deployed in a destination region, the destination region being different from the source region, and the destination cluster being deployed with a destination access layer and a destination control layer; and replicate the mirror meta-information in the source database to a destination database through the destination access layer based on the mirror replication request, the mirror file information to be replicated, and the destination cluster information.

The source control layer is configured to: obtain the mirror replication request, and replicate the mirror file to be replicated in the source mirror repository to a destination mirror repository through the destination control layer based on the mirror replication request, the mirror file information to be replicated, and the destination cluster information.

In some embodiments, the source control layer is further configured to: generate a mirror replication task based on the mirror replication request; write the mirror replication task and corresponding task information into the source database, the task information corresponding to the mirror replication task including the mirror file information to be replicated and the destination cluster information; obtain the mirror replication task from the source database; obtain the task information corresponding to the mirror replication task; and synchronize the mirror file to be replicated to the destination control layer based on the mirror file information to be replicated and the destination cluster information in response to performing the mirror replication task, to write, by the destination control layer, the mirror file to be replicated into the destination mirror repository.

In some embodiments, the source control layer is further configured to: synchronize the mirror file to be replicated to the destination control layer based on the port opened by the destination control layer and the mirror file information to be replicated, to write, by the destination control layer, the mirror file to be replicated into the destination mirror repository; and invoke, based on the destination cluster information in response to determining that synchronization of the mirror file to be replicated is completed, the destination control layer to close the port opened by the destination control layer.

In some embodiments, the source control layer is further configured to: send a request for opening a mirror synchronization port to the destination control layer based on the destination cluster information in response to performing the mirror replication task, to randomly open, by the destination control layer, at least one port in a target port range based on the request for opening a mirror synchronization port.

In some embodiments, the source control layer is further configured to: send the request for opening a mirror synchronization port to the destination control layer based on the destination cluster information in response to performing the mirror replication task, to generate, by the destination control layer based on the request for opening a mirror synchronization port, a task for opening a mirror synchronization port, write the task for opening a mirror synchronization port into the destination database, return an identification of the task for opening a mirror synchronization port, obtain the task for opening a mirror synchronization port from the destination database, and open at least one port in response to performing the task for opening a mirror synchronization port

In some embodiments, the source control layer is further configured to: determine, based on the identification of the task for opening a mirror synchronization port, whether the opening succeeds; and synchronize, if it is determined that the opening succeeds, the mirror file to be replicated to the destination control layer based on the port opened by the destination control layer and the mirror file information to be replicated, to write, by the destination control layer, the mirror file to be replicated into the destination mirror repository.

In some embodiments, the source control layer is further configured to: synchronize the mirror file to be replicated by using a file transfer tool based on the mirror file information to be replicated and the port opened by the destination control layer, to detect the port opened by the destination control layer, receive the mirror file to be replicated, and write, by the destination control layer, the mirror file to be replicated into the destination mirror repository by using the file transfer tool.

In some embodiments, the source control layer is further configured to: start a main process to perform the mirror replication task, invoke, based on the destination cluster information, the destination control layer to open the mirror synchronization port, start a sub-process in the main process, run the file transfer tool in the sub-process, and synchronize the mirror file to be replicated based on the port opened by the destination control layer and the mirror file information to be replicated.

In some embodiments, the source control layer is further configured to: query a size of a synchronized mirror file to be replicated in the main process; obtain a total size of the mirror file to be replicated in the main process; obtain replication progress information of the mirror file to be replicated in the main process based on the size of the synchronized mirror file to be replicated and the total size of the mirror file to be replicated; and update task progress information corresponding to the mirror replication task in the source database in the main process based on the replication progress information of the mirror file to be replicated.

In some embodiments, the source control layer is further configured to: obtain mirror hierarchical information of the mirror file information to be replicated from the source database based on the mirror file information to be replicated in response to performing the mirror replication task; invoke, based on the mirror hierarchical information of the mirror file to be replicated and the destination cluster information, the destination control layer to query whether all layers of the mirror file to be replicated exist in the destination mirror repository; obtain a query result from the destination control layer; and if it is determined, based on the query result, that not all layers of the mirror file to be replicated exist in the destination mirror repository, invoke, based on the destination cluster information, the destination control layer to open a mirror synchronization port to-be-replicated.

In some embodiments, the source control layer includes a source control layer interface. The source control layer interface is configured to: obtain the mirror replication request from the source access layer; generate the mirror replication task based on the mirror replication request; and write the mirror replication task and the corresponding task information into the source database.

In some embodiments, the source control layer interface is further configured to: parse the mirror replication request, to obtain a parameter of the mirror replication request, the parameter of the mirror replication request including the mirror file information to be replicated and the destination cluster information; perform validity check on the mirror file information to be replicated and the destination cluster information respectively, to obtain a validity check result; and generate the mirror replication task based on the parameter of the mirror replication request if the validity check result indicates that the validity check succeeds.

In some embodiments, the source access layer is further configured to obtain the mirror meta-information from the source database based on the mirror file information to be replicated; and synchronize the mirror meta-information to the destination access layer based on the destination cluster information, to write, by the destination access layer, the mirror meta-information into the destination database.

In some embodiments, a mirror processing apparatus is provided. The apparatus is deployed in a destination cluster in a destination region. The apparatus includes a destination access layer and a destination control layer.

The destination access layer is configured to: receive mirror meta-information of a mirror file to be replicated from a source access layer of a source cluster, the source cluster being deployed in a source region, the source region being different from the destination region, the source cluster being deployed with the source access layer and a source control layer, the source cluster being deployed with a source mirror repository and a source database, the source mirror repository storing the mirror file to be replicated, and the source database storing the mirror meta-information; and the destination access layer being further configured to write the mirror meta-information into a destination database.

The destination control layer is configured to: receive the mirror file to be replicated from the source control layer, and write the mirror file to be replicated into the destination mirror repository.

For modules in the apparatus provided in some embodiments, reference may be made to descriptions of the foregoing method.

FIG. 20 is a schematic structural diagram of an electronic device according to some embodiments. The device shown in FIG. 20 only uses a computer system as an example, and does not limit the function and the scope of the disclosure.

As shown in FIG. 20, a device 2000 includes a central processing unit (CPU) 2001, and the central processing unit may perform various appropriate actions and processes based on a program stored in a read-only memory (ROM) 2002 or a program loaded to a random access memory (RAM) 2003 from a storage part 2008. Various programs and data for operations of the device 2000 are stored in the RAM 2003. The CPU 2001, the ROM 2002, and the RAM 2003 are connected through a bus 2004. An input/output (I/O) interface 2005 is connected to the bus 2004.

The following components are connected to the I/O interface 2005, including an input part 2006 of a keyboard, a mouse, and the like; including an input part 2007 of a cathode ray tube (CRT), a liquid crystal display (LCD), a speaker, and the like; including a storage part 2008 of hardware; and including a communication part 2009 of a network interface card such as a local area network (LAN) card, a modem, and the like. The communication part 2009 performs communication processing via a network such as the internet. A driver 2010 is also connected to the I/O interface 2005. A removable media 2011, such as a magnetic disk, an optical disk, a magneto-optical disk, a semiconductor memory, and the like are installed on the drive 2010, so that it may be read that computer-readable instructions is installed to the storage part 2008.

Based on some embodiments, the process described foregoing with reference to the flowchart may be implemented as a computer software program. For example, some embodiments include a computer program product, including computer-readable instructions carried in a computer-readable medium, the computer-readable instructions including program code configured to perform the method shown in the flowchart. In some embodiments, the computer program product may be uploaded and installed from the network through the communication part 2009, and/or be installed from the removable media 2011. When the computer-readable instructions of the computer program product are executed by the CPU 2001, the foregoing functions defined in the system of some embodiments are performed.

The computer-readable medium shown in some embodiments may be a computer-readable signal medium or a computer-readable storage medium, or any combination of the computer-readable signal medium and the computer-readable storage medium. The computer-readable storage medium may be, for example, but is not limited to, an electrical, magnetic, optical, electromagnetic, infrared, or a semiconductor system, apparatus or component, or any combination thereof. Examples of the computer-readable storage medium may include but are not limited to an electrical connection having one or more wires, a portable computer diskette, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any combination of thereof. In some embodiments, the computer-readable storage medium may be any tangible medium that includes or stores a program. The program may be used by an instruction execution system, apparatus, or device, or may be used by a combination of the instruction execution system, apparatus, or device. In some embodiments, the computer-readable signal medium may include a data signal propagated in a baseband or as a part of a carrier, and computer-readable program code is carried in the data signal. The propagated data signal may use various forms, including but not limited to an electromagnetic signal, an optical signal, or any appropriate combination of thereof. The computer-readable signal medium may further be any computer-readable medium other than the computer-readable storage medium. The computer-readable medium may send, propagate, or transmit a program used by the instruction execution system, apparatus, or device or used in combination with the instruction execution system, apparatus, or device. The program code included in the computer-readable medium may be transmitted by using any medium, including but not limited to a wireless medium, an electric line, an optical cable, an RF, or the like, or any combination thereof.

Flowcharts and block diagrams in the drawings illustrate architectures, functions, and operations that may be implemented using the system, the method, and the computer program product according to some embodiments. Each block in the flowchart or the block diagram may represent a module, a program segment, or a part of code. The module, the program segment, or the part of the code include one or more computer-readable instructions for implementing various logical functions. In some embodiments, the functions noted in the block may occur not in sequence noted in the drawings. For example, two blocks shown one after another may actually be executed substantially in parallel, or the two blocks may sometimes be executed in a reverse order. This depends on the functions involved. Each box in the block diagram or the flowchart and a combination of boxes in the block diagram or the flowchart may be implemented may using a dedicated hardware-based system configured to execute a function or operation, or may be implemented by using a combination of dedicated hardware and computer instructions.

Some embodiments further provide a computer-readable medium. The computer-readable medium may be included in the device described in some embodiments, or may exist alone and not be assembled into the device. The computer-readable medium carries one or more programs, and when the one or more programs are executed by the device, the device implements the method including:
obtaining, by a source access layer, a mirror replication request; replicating, by the source access layer, mirror meta-information in a source database to a destination database through a destination access layer based on the mirror replication request, mirror file information to be replicated, and destination cluster information; obtaining, by a source control layer, the mirror replication request; and replicating, by the source control layer, a mirror file to be replicated in a source mirror repository to a destination mirror repository through a destination control layer based on the mirror replication request, the mirror file information to be replicated, and the destination cluster information.

Some embodiments provide a computer program product or a computer program, the computer program product or the computer program including computer instructions, and the computer instructions being stored in a computer-readable storage medium. A processor of an electronic device reads the computer instructions from the computer-readable storage medium, and the processor performs the computer instructions, so that the electronic device performs the methods provided in the foregoing various optional implementations.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A mirror processing method, performed by a source cluster deployed in a source region, the mirror processing method comprising:
obtaining a mirror replication request, via a source access layer of the source cluster, wherein the mirror replication request comprises mirror file information to be replicated and destination cluster information corresponding to a destination cluster deployed in a destination region different from the source region, and wherein the destination cluster is deployed with a destination access layer and a destination control layer;
replicating mirror meta-information in a source database of the source cluster, via the source access layer, to a destination database of the destination cluster, by transmitting the mirror meta-information to the destination access layer, based on the mirror replication request;
obtaining the mirror replication request via a source control layer of the source cluster; and
replicating a mirror file in a source mirror repository of the source cluster, via the source control layer, to a destination mirror repository of the destination cluster, by transmitting the mirror file to the destination control layer, based on the mirror replication request.

2. The mirror processing method according to claim 1, wherein the replicating the mirror file comprises:
generating a mirror replication task, via the source control layer, based on the mirror replication request;
writing the mirror replication task and corresponding task information, via the source control layer, into the source database, wherein the task information comprises the mirror file information and the destination cluster information;
obtaining the mirror replication task and the task information from the source database, via the source control layer;
performing the mirror replication task via the source control layer; and
synchronizing the mirror file with the destination cluster, by transmitting the mirror file, via the source control layer, to the destination control layer, based on the mirror file information and the destination cluster information, in response to performing the mirror replication task, to cause the destination cluster to write the mirror file into the destination mirror repository.

3. The mirror processing method according to claim 2, wherein the synchronizing the mirror file with the destination cluster comprises:
invoking the destination control layer to open a mirror synchronization port, via the source control layer, based on the destination cluster information, in response to performing the mirror replication task;
transmitting the mirror file, via the source control layer, to the destination control layer, based on the mirror synchronization port and the mirror file information, to cause the destination cluster to write the mirror file into the destination mirror repository; and
invoking the destination control layer, via the source control layer, to close the mirror synchronization port, based on the destination cluster information, in response to determining the synchronizing the mirror file is complete.

4. The mirror processing method according to claim 3, wherein the invoking the destination control layer to open the mirror synchronization port comprises:
transmitting a request for opening the mirror synchronization port, via the source control layer, to the destination control layer, based on the destination cluster information, in response to performing the mirror replication task, to cause the destination cluster to randomly open at least one port in a target port range.

5. The mirror processing method according to claim 3, wherein the invoking the destination control layer to open the mirror synchronization port comprises:
transmitting a request for opening the mirror synchronization port, via the source control layer, to the destination control layer, based on the destination cluster information, in response to performing the mirror replication task, to cause the destination cluster to generate a task for opening the mirror synchronization port, write the task into the destination database, return an identification of the task, obtain the task from the destination database, and open at least one port.

6. The mirror processing method according to claim 5, wherein the transmitting the mirror file to the destination control layer comprises transmitting the mirror file to the destination control layer, via the source control layer based on the mirror file information and determining the opening the mirror synchronization port succeeded, to cause the destination cluster to write the mirror file into the destination mirror repository.

7. The mirror processing method according to claim 3, wherein the transmitting the mirror file to the destination control layer comprises transmitting the mirror file to the destination control layer, via the source control layer, by using a first file transfer tool to detect a port opened by the destination control layer, based on the mirror synchronization port and the mirror file information, wherein the first file transfer tool detects an opened mirror synchronization port of the destination control layer and transmits the mirror file to the destination control layer, via the opened mirror synchronization port, to cause the destination cluster to, via a second file transfer tool of the destination cluster, receive the mirror file and write the mirror file into the destination mirror repository.

8. The mirror processing method according to claim 7, wherein the invoking the destination control layer to open the mirror synchronization port comprises:
starting a main process, via the source control layer, to perform the mirror replication task; and
invoking the destination control layer, via the source control layer, to open the mirror synchronization port, based on the destination cluster information, and
wherein the transmitting the mirror file using the first file transfer tool comprises:
starting a sub-process of the main process, via the source control layer, running the first file transfer tool; and
transmitting the mirror file, using the first file transfer tool, to the destination control layer, based on the opened mirror synchronization port and the mirror file information.

9. The mirror processing method according to claim 8, further comprising:
querying the main process, via the source control layer, to obtain an amount of the mirror file that has been synchronized;
obtaining a total size of the mirror file via the source control layer;
obtaining replication progress information of the mirror file, via the source control layer, based on the amount of the mirror file to that has been synchronized and the total size of the mirror file; and
updating task progress information, corresponding to the mirror replication task, in the source database, via the source control layer during execution of the main process, based on the replication progress information.

10. The mirror processing method according to claim 3, wherein the invoking the destination control layer to open the mirror synchronization port comprises:
obtaining mirror hierarchical information of the mirror file, via the source control layer, from the source database, based on the mirror file information, in response to the performing the mirror replication task;
invoking the destination control layer, via the source control layer, based on the mirror hierarchical information and the destination cluster information, to cause the destination cluster to query whether all layers of the mirror file exist in the destination mirror repository;
obtaining a query result, via the source control layer, from the destination control layer; and
based on determining, via the source control layer, based on the query result, that not all layers of the mirror file exist in the destination mirror repository, invoking the destination control layer, via the source control layer, based on the destination cluster information, to open the mirror synchronization port.

11. A mirror processing apparatus, deployed in a source cluster of a source region, comprising:
at least one memory configured to store computer program code; and
at least one processor configured to read the program code and operate as instructed by the program code, the program code comprising:
first obtaining code configured to cause at least one of the at least one processor to obtain a mirror replication request, via a source access layer of the source cluster, wherein the mirror replication request comprises mirror file information to be replicated and destination cluster information corresponding to a destination cluster deployed in a destination region different from the source region, and wherein the destination cluster is deployed with a destination access layer and a destination control layer;
first replicating code configured to cause at least one of the at least one processor to replicate mirror meta-information in a source database of the source cluster, via the source access layer, to a destination database of the destination cluster, by transmitting the mirror meta-information to the destination access layer, based on the mirror replication request;
second obtaining code configured to cause at least one of the at least one processor to obtain the mirror replication request via a source control layer of the source cluster; and
second replicating code configured to cause at least one of the at least one processor to replicate a mirror file in a source mirror repository of the source cluster, via the source control layer, to a destination mirror repository of the destination cluster, by transmitting the mirror file to the destination control layer, based on the mirror replication request.

12. The mirror processing apparatus according to claim 11, wherein the second replicating code is configured to cause at least one of the at least one processor to:
generate a mirror replication task, via the source control layer, based on the mirror replication request;
write the mirror replication task and corresponding task information, via the source control layer, into the source database, wherein the task information comprises the mirror file information and the destination cluster information;
obtain the mirror replication task and the task information from the source database, via the source control layer;
perform the mirror replication task via the source control layer; and
synchronize the mirror file with the destination cluster, by transmitting the mirror file, via the source control layer, to the destination control layer, based on the mirror file information and the destination cluster information, in response to performing the mirror replication task, to cause the destination cluster to write the mirror file into the destination mirror repository.

13. The mirror processing apparatus according to claim 12, wherein the second replicating code is configured to cause at least one of the at least one processor to:
invoke the destination control layer to open a mirror synchronization port, via the source control layer, based on the destination cluster information, in response to performing the mirror replication task;
transmit the mirror file, via the source control layer, to the destination control layer, based on the mirror synchronization port and the mirror file information, to cause the destination cluster to write the mirror file into the destination mirror repository; and
invoke the destination control layer, via the source control layer, to close the mirror synchronization port, based on the destination cluster information, in response to determining the synchronizing the mirror file is complete.

14. The mirror processing apparatus according to claim 13, wherein the second replicating code is configured to cause at least one of the at least one processor to:
transmit a request for opening the mirror synchronization port, via the source control layer, to the destination control layer, based on the destination cluster information, in response to performing the mirror replication task, to cause the destination cluster to randomly open at least one port in a target port range.

15. The mirror processing apparatus according to claim 13, wherein the second replicating code is configured to cause at least one of the at least one processor to:
transmit a request for opening the mirror synchronization port, via the source control layer, to the destination control layer, based on the destination cluster information, in response to performing the mirror replication task, to cause the destination cluster to generate a task for opening the mirror synchronization port, write the task into the destination database, return an identification of the task, obtain the task from the destination database, and open at least one port.

16. The mirror processing apparatus according to claim 15, wherein the second replicating code is configured to cause at least one of the at least one processor to transmit the mirror file to the destination control layer, via the source control layer based on the mirror file information and determining the opening the mirror synchronization port succeeded, to cause the destination cluster to write the mirror file into the destination mirror repository.

17. The mirror processing apparatus according to claim 13, wherein the second replicating code is configured to cause at least one of the at least one processor to transmit the mirror file to the destination control layer, via the source control layer, by using a first file transfer tool to detect a port opened by the destination control layer, based on the mirror synchronization port and the mirror file information, wherein the first file transfer tool detects an opened mirror synchronization port of the destination control layer and transmits the mirror file to the destination control layer, via the opened mirror synchronization port, to cause the destination cluster to, via a second file transfer tool of the destination cluster, receive the mirror file and write the mirror file into the destination mirror repository.

18. The mirror processing apparatus according to claim 17, wherein the second replicating code is configured to cause at least one of the at least one processor to:
start a main process, via the source control layer, to perform the mirror replication task;
invoke the destination control layer, via the source control layer, to open the mirror synchronization port, based on the destination cluster information;
start a sub-process of the main process, via the source control layer, running the first file transfer tool; and
transmit the mirror file, using the first file transfer tool, to the destination control layer, based on the opened mirror synchronization port and the mirror file information.

19. The mirror processing apparatus according to claim 18, wherein the program code further comprises updating code configured to cause at least one of the at least one processor to:
query the main process, via the source control layer, to obtain an amount of the mirror file that has been synchronized;
obtain a total size of the mirror file via the source control layer;
obtain replication progress information of the mirror file, via the source control layer, based on the amount of the mirror file to that has been synchronized and the total size of the mirror file; and
update task progress information, corresponding to the mirror replication task, in the source database, via the source control layer during execution of the main process, based on the replication progress information.

20. A non-transitory computer-readable storage medium, storing computer code which, when executed by at least one processor, causes the at least one processor to at least:
obtain a mirror replication request, via a source access layer of a source cluster, wherein the mirror replication request comprises mirror file information to be replicated and destination cluster information corresponding to a destination cluster deployed in a destination region different from a source region of the source cluster, and wherein the destination cluster is deployed with a destination access layer and a destination control layer;
replicate mirror meta-information in a source database of the source cluster, via the source access layer, to a destination database of the destination cluster, by transmitting the mirror meta-information to the destination access layer, based on the mirror replication request;
obtain the mirror replication request via a source control layer of the source cluster; and
replicate a mirror file in a source mirror repository of the source cluster, via the source control layer, to a destination mirror repository of the destination cluster, by transmitting the mirror file to the destination control layer, based on the mirror replication request.
